(19) United States
(12) Patent Application Publication
(10) Pub. No.: US 2011/0187731 A1
(43) Pub. Date: Aug. 4, 2011

(54) MARKER DISPLAY CONTROL DEVICE, INTEGRATED CIRCUIT, AND MARKER DISPLAY CONTROL METHOD

(76) Inventor: Yasuhiro Tsuchida, Osaka (JP)

(21) Appl. No.: 13/063,359

(22) PCT Filed: Jul. 9, 2010
(86) PCT No.: PCT/JP2010/004476

§ 371 Date: Mar. 10, 2011

(30) Foreign Application Priority Data
Jul. 10, 2009 (JP) 2009-163433

(51) Int. Cl. G09G 5/00

(52) U.S. Cl. 345/581

(57) ABSTRACT

Aims to be provided is a marker display control device which facilitates detection of markers, while reducing the loss of viewability of a screen picture, which is the display contents to be primarily presented on a display apparatus. The marker display control device includes a marker detecting unit for detecting a marker from an image obtained by shooting the display apparatus and a marker-display-mode changing unit for instructing the display apparatus to change the display mode of the detected marker, based on the marker detection. For example, the marker display control device reduces the display area occupied by the marker to reduce the loss of viewability of what is displayed on the display apparatus, while ensuring that the marker remains in a detectable size.

### TECHNICAL FIELD

The present invention relates to a marker display control device for controlling a display apparatus to display, on a display screen (display area) of the display apparatus, one or more markers used to recognize the display apparatus. More specifically, the present invention relates to a marker display control device for controlling a display apparatus to display one or more markers with a screen picture that is the display contents primarily intended to be presented to users.

### BACKGROUND ART

A marker represents identification information by its color and shape and may be referred to as an identification mark. It has been practiced to pick up an image of an object attached with such a marker to acquire identification information represented by the marker in order, for example, to identify the object or locate the position of the object in the image shot (i.e., captured) with a camera.

Patent literature 1 describes a technology for using an information processing terminal equipped with a camera as a remote controller. By shooting an image of an identification code (marker) attached to an electronic device, the information processing terminal recognizes the electronic device to be controlled, from among a plurality of electronic device that may be around. This eliminates the need for the user to manually select the electronic device to be controlled. However, this technology requires labor of preparing enough labels printed with markers for the respective electronic devices and attaching the labels to the electronic devices one by one.

In an attempt to save such labor, Patent literature 2 discloses the following technology. That is, a mobile terminal is controlled to display a marker on a display screen. Then, by shooting an image of the marker, the type of an image associated with the marker is recognized, along with the position of the marker in the shot image. With this technology, any of a plurality of different markers is freely displayed on the display screen of the mobile terminal, which eliminates the need for preparing labels printed with markers corresponding to different types of images.

### CITATION LIST

### Patent Literature

[Patent Literature 1] JP patent application publication No. 2001-142845
[Patent Literature 2] JP patent application publication No. 2005-250950

### SUMMARY OF INVENTION

### Technical Problem

It has been requested that a display apparatus, such as a television, to be able to display one or more markers on the display screen (display area) together with a screen picture, so that the markers are used for setting the display apparatus as a control target. Note that the term “screen picture” refers to the displayed contents to be primarily presented by the display apparatus. Examples of screen pictures include an operation menu and motion pictures. For example, by shooting an image of a marker displayed on a display apparatus and identifying the marker, the type and position of the display apparatus is recognized, which facilitates remote control of the display apparatus.

However, there is a problem that any marker presented on the display apparatus may interfere with viewing the screen picture also presented on the display apparatus. One way to address the above problem is to reduce the region of the display screen occupied by the markers or to display each marker near an edge (especially at a corner) of the display screen. With this approach, the markers become less noticeable, so that the loss of viewability of the screen picture is reduced (i.e., interference with viewing is reduced).

Yet, by merely making markers less noticeable, a risk arises that the markers cannot be detected reliably. For example, there may be a case where the shooting distance for image shooting is rather long depending on the location of the user. In such a case, it may be difficult to detect small markers. In another example, in the case where only a small number of markers are displayed or markers are displayed near the edge of the display screen, the risk is increased that a marker is obstructed from line of sight at the time of image shooting and cannot be detected reliably.

The present invention is made in view of the above problems and aims to provide a marker display control device which facilitates marker detection while reducing the loss of viewability of a screen picture, which is the displayed contents to be primarily presented on the display apparatus.

### Solution to Problem

In order to solve the problems noted above, the present invention provides a marker display control device for controlling one or more display apparatuses connected thereto via a communications unit, so that each display apparatus displays a marker to be used for recognizing the display apparatus. The marker display control device includes: a marker detecting unit operable to detect a marker from a shot image of a display screen of one of the display apparatuses, the marker to be used for recognizing the display apparatus; and a marker-display-mode changing unit operable to instruct, based on a result of the marker detection, the display apparatus displaying the marker to change a display mode of the marker.

### Advantageous Effects of Invention

The marker display control device according to the present invention controls a display apparatus to display a marker in larger size in the display area until the marker is detected and to reduce the display size of the marker after the marker detection. In this way, the marker display control device facilitates the marker detection while reducing the loss of viewability of the display a screen picture, which is the displayed contents to be primarily presented on the display apparatus. In another example, the marker display control device according to the present invention controls a display apparatus to display a marker in small size in the display area in a normal state, and increase the display size if the marker detection fails due to the long shooting distance. In this way, the marker detection is facilitated.

In short, the marker display control device according to the present invention achieves to facilitate marker detection, while reducing the loss of viewability of a screen picture, which is the displayed contents to be primarily presented on the display apparatus.

### BRIEF DESCRIPTION OF DRAWINGS

FIG. 1 is a block diagram showing the structures of a portable information terminal 1 and a television 2 according to Embodiment 1 of the present invention.

FIG. 2 is a view showing the external representations of the portable information terminal 1 and the television 2, along with their arrangement according to Embodiment 1.

FIG. 3 is a flowchart showing a process of controlling a display device performed by the portable information terminal 1 according to Embodiment 1.

FIG. 4 is a flowchart showing a process performed by the television 2 according to Embodiment 1.

FIG. 5 is a flowchart showing a process of marker detection according to Embodiment 1.

FIG. 6 is a flowchart showing a process of adjusting a marker size according to Embodiment 1.

FIG. 7 is a table showing the contents stored in a marker information storing unit 133 at the time of an initialization process according to Embodiment 1.

FIGS. 8A and 8B are views showing a shot image 111 of a marker according to Embodiment 1.

FIG. 9 is a table showing the contents stored in the marker information storing unit 133 at the time of when a marker is detected according to Embodiment 1.

FIG. 10 is a table showing the contents stored in the marker information storing unit 133 after marker size adjustment according to Embodiment 1.

FIG. 11 a table showing the names of reference colors and the reference brightness values of respective color components according to Embodiment 1.

FIG. 12 is a view showing the external representations of the portable information terminal 1 and the television 2 along with their arrangement, in a state after the marker size adjustment according to Embodiment 1.

FIG. 13 is a flowchart showing a process of non-use detection according to Modification 1 of Embodiment 1.

FIG. 14 is a flowchart showing a marker detection process 2 according to Modification 1.

FIG. 15 is a block diagram showing the structures of a portable information terminal 500 and a television 2 according to Embodiment 2 of the present invention.

FIG. 16 is a table showing the contents stored in the marker information storing unit 133 according to Embodiment 2.

FIG. 17 is a view showing the external representations of the portable information terminal 500, the television 2, etc., along with their exemplary arrangement according to Embodiment 2.

FIG. 18 is a flowchart showing a marker size adjusting process 2 according to Embodiment 2.

FIG. 19 is a flowchart showing an undetectable marker process according to Embodiment 2.

FIG. 20 is a block diagram showing the structures of a portable information terminal 600 and a television 2 according to Embodiment 3 of the present invention.

FIG. 21 is a view showing the portable information terminal 600 and the television 2 according to Embodiment 3.

FIG. 22 is a view showing an exemplary arrangement of the portable information terminal 600, the television 2, etc., according to Embodiment 3.

FIG. 23 is a table showing the contents stored in the marker information storing unit 133 according to Embodiment 3.

FIG. 24 is a flowchart showing an undetectable marker process 2 according to Embodiment 3.

FIG. 25 is a flowchart showing a process of detecting an obstructed state according to Embodiment 3.

FIG. 26 is a flowchart showing a process of shifting the display position of a marker according to Embodiment 3.

FIG. 27 is a flowchart showing a process of calculating the shift amount according to Embodiment 3.

FIG. 28 is a table showing the contents stored in the marker information storing unit 133 according to Embodiment 3.

FIG. 29 is a view showing an exemplary arrangement of the portable information terminal 600, the television 2, etc., and an obstruction 4, according to Embodiment 3.

FIG. 30 is a view showing a table of directions for shifting a marker to be determined based on the display position of the marker and a random number, according to Modification of Embodiment 3.

FIG. 31 is a view showing the contents stored in the marker information storing unit 133 after marker shift according to Modification of Embodiment 3.

FIG. 32 is a view showing an example of two-dimensional marker.

FIG. 33 is a block diagram showing the structures of an operation device 700, a display apparatus 702, etc., according to an embodiment different from the embodiments mentioned above.

### DESCRIPTION OF EMBODIMENT

### Various Aspects of Invention

The following are examples of various possible aspects of the present invention and relevant descriptions.

(1) According to one aspect of the present invention, a marker display control device is for controlling one or more display apparatuses connected thereto via a communications unit, so that each display apparatus displays a marker to be used for recognizing the display apparatus. The marker display control device includes: a marker detecting unit operable to detect a marker from a shot image of a display screen of one of the display apparatuses, the marker to be used for recognizing the display apparatus; and a marker-display-mode changing unit operable to instruct, based on a result of the marker detection, the display apparatus displaying the marker to change a display mode of the marker.

The marker display control device according to this aspect is incorporated into, for example, an operation device for remotely controlling a display apparatus.

With the marker display control device according to this aspect, the display size of a marker is reduced after, for example, the marker is duly detected. As a result, the loss of viewability of the display screen is reduced. The marker display control device according to this aspect also facilitates the marker detection when, for example, detection of a marker fails. In such a case, the marker display control device may enlarge the display size of the marker or changes the display position of the marker (shifting the marker) to facilitate the marker detection performed thereafter.

In short, the marker display control device according to the present invention achieves to facilitate marker detection, while reducing the loss of viewability of the screen picture displayed on the display screen of the display apparatus.

According to this aspect, each marker is used to identify the type of the display apparatus or to locate the position of the display screen of the display apparatus in a shot image.

By identifying the type of the display apparatus appearing in a shot image, the marker display control device is enabled to specify a display apparatus targeted for user operations from among a plurality of other display apparatuses that may be around the user. In addition, by locating the position of the display screen of the display apparatus, the marker display control device allows the user to remotely operate an operation menu displayed on the display screen of the display apparatus, by operating the operation menu appearing in the shot image displayed on the operation device held at hand. More specifically, when an operation menu is displayed on the display apparatus and a shot image of the operation menu is displayed on the display unit of the operation device, the user can specify a point on the operant menu appearing in the shot image. In response, the operation device transmits, to the display apparatus, information indicating the coordinates of a corresponding point on the actual display screen of the display apparatus. As a consequence, the display apparatus receives the user operation and interprets that a menu item displayed at the specified coordinates is selected.

Note that examples of changes to the marker display mode include a change to the total display area occupied by the marker, a change to the display position of the marker, and a change to the configuration (such as shape and color) of the marker. Examples of changes to the total display area occupied by the marker include a change to the size of each marker (display size) and a change of the number of markers displayed.

Note that “to instruct to change a display mode of the marker, based on a result of the marker detection” may refer to, for example, issuing an instruction to reduce the total display area occupied by the marker (i.e., to reduce the display size of each marker, reduce the number of markers displayed, or the like). With this instruction, the total display area occupied by the marker is increased to enable the marker to be easily detected. After the marker is duly detected and the total display area occupied by the marker can be reduced.

In addition, “to instruct to change a display mode of the marker, based on a result of the marker detection” may refer to, for example, issuing an instruction to enlarge the size of the marker or to change the display position of the marker, in the event that the marker detection fails. By enlarging the size of a marker, the marker become duly detectable even if the marker detection once failed due to, for example, the long shooting distance. In addition, by changing the display position of a marker, the possibility is increased that the marker is duly detected, even if the marker detection once failed because the marker is obstructed by, for example, an obstruction placed in front of the display apparatus and an image of part (where the marker is displayed) of the display apparatus is not captured.

An “instruction” may be issued by, for example, transmitting a predetermined signal to the display apparatus, or transmitting information indicating the display size and/or position of a marker to the display apparatus.

Note that an shot image used in the marker detection performed by a marker detecting unit has been encoded. That is, a marker is detected from image information obtained by encoding a shot image.

The display apparatus may be composed solely of a display device having an image displaying function, such as a television receiver or a notebook personal computer. Alternatively, the display apparatus may be a combination of a display device and an image playback device. An image playback device is composed, for example, of a DVD player (recorder), an HDD recorder, a video camera, a PC (personal computer) etc.

Note that the display area of a display apparatus refers to a two-dimensional area where a display screen of the display apparatus is disposed. In addition, the display area is substantially equal in size to the display screen.

The communications unit may be composed, for example, of a communications apparatus, such as an infrared communications apparatus or a wireless LAN (Local Area Network) apparatus. Note that it is sufficient that the communications unit (communications apparatus) is capable of at least one-way information transmission. The communications unit may therefore be referred to as a sending unit (sending apparatus). In order to clarify that the communications unit is capable of one-way or two-way information transmission, the communications unit may be referred to as an information conveying unit (information conveying apparatus). Note that the wording “via the communications unit” means “by the communications unit”

(2) According to another aspect of the present invention pertaining to the marker display control device, the marker-display-mode changing unit may instruct the display apparatus displaying the marker detected by the marker detecting unit to reduce a total display area occupied by the marker.

According to this aspect, after confirming that the marker is detectable, the marker display control device causes the display apparatus to reduce the display size of each marker and/or the number of markers displayed. As a result, it is achieved to reduce the loss of viewability of the screen picture displayed on the display apparatus. Therefore, for example, the marker display control device may control the display apparatus to display a relatively large-sized marker on the display screen and then reduce the size once the marker has been duly detected.

According to this aspect, it is preferable that the marker-display-mode changing unit issues an instruction to reduce the total display area occupied by the marker, if the predetermined condition is satisfied. The predetermined condition is satisfied when, for example, the size of a marker appearing in a shot image is larger than the minimum size to be detectable as a marker.

(3) According to yet another aspect of the present invention, the marker display control device may further include an image shooting unit operable to repeatedly shoot images of the marker. The marker detecting unit may detect the marker from the images sequentially shot by the image shooting unit. When the marker detecting unit fails to detect a marker that was detected in a previous detection, the marker-display-mode changing unit may instruct a display apparatus displaying the marker failed to be detected to increase a display size, or to change a display position, of the marker failed to be detected.

According to this aspect, the marker detection is facilitated even if the marker detection once failed because, for example, the marker display size is too small or because the marker is hidden behind an obstruction. More specifically, detection of a marker is facilitated by enlarging the display size of the marker or changing the display position of the marker.

Therefore, in normal times, the total display area occupied by the marker is kept relatively small or each marker is displayed at a position near the edge of the display area. As a result, it is achieved to reduce the loss of viewability of the screen picture displayed on the display apparatus.

The image shooting unit may be composed, for example, of a digital camera or digital video camera.

(4) According to yet another aspect of the present invention, the marker display control device may further include a marker information storing unit that stores, for each marker, a piece of marker information including (i) information indicating a display apparatus associated with the marker, (ii) marker identification information indicating a marker color assigned to the associated display apparatus, and (iii) a display size of the marker on the associated display apparatus.

According to this aspect, the marker display control device ensures, for example, that the marker is detected based on the marker identification information and that the display apparatus to be operated is recognized based on the information associated with the detected marker. In addition, the marker display control device appropriately designates, based on the display size of a marker, a smaller size than the current display size to reduce the marker or a larger size than the current display size to enlarge the marker.

According to this aspect, the marker information storing unit is provided within the marker display control device. According to yet another aspect, however, the marker information storing unit may be external to the marker display control device. Suppose that the marker display control device is incorporated in an operation device, such as a portable information terminal. In this case, the marker information storing unit may be provided within a component of the operation device other than the marker display control device. In this case, the marker display control device acquires marker information from the component having the marker information storing unit.

(5) According to yet another aspect of the present invention pertaining to the marker display control device, the display apparatus may have a function of displaying a plurality of markers at separate locations on a display area of the display apparatus. The marker-display-mode changing unit may include a marker state determining unit. When a marker displayed on the display apparatus is currently undetectable by the marker detecting unit as a result of the marker being hidden behind an obstruction or that the marker falls outside an image shooting range of the image shooting unit, the marker state determining unit may determine that the undetectable marker is in a predetermined state. The marker-display-mode changing unit may instruct to change the display position of the marker determined by the marker state determining unit as being in the predetermined state.

According to this aspect, the marker in the predetermined state is shifted to another display position, so that detection of the marker is facilitated. Therefore, by causing a marker to be displayed near the edge of the display area or a smaller number of markers to be displayed, it is made easier to reduce the loss of viewability of a screen picture displayed on the display apparatus.

Examples of the predetermined state include a state where a marker displayed on the display apparatus is hidden behind an obstruction and thus an image of the marker cannot be captured and a state where a marker is located outside an image shooting (i.e., capturing) area and thus an image of the marker cannot be captured.

(6) According to yet another aspect of the present invention pertaining to the marker display control device, the marker-display-mode changing unit may instruct to change the display position of the marker determined as being in the predetermined state toward a center of the display area in at least one of vertical and horizontal directions, while the display position of each marker other than the marker determined as being in the predetermined state is retained at a different one of four corners of the display area.

According to this aspect, the marker display control device causes the display apparatus to shift a marker displayed at a corner of the display area to a position closer toward the center of the display area to facilitate that the marker is duly detected.

(7) According to yet another aspect of the present invention pertaining to the marker display control device, the marker-display-mode changing unit may instruct the display apparatus to reduce a display size of the marker appearing in the shot image to a size that is smaller than a size of the marker as detected by the marker detecting unit and no smaller than a predetermined minimum size for ensuring a marker to be detectable from a shot image.

According to this aspect, the minimum size of a detectable marker is determined in advance in terms of the marker size appearing in an image obtained by shooting what is displayed on the display screen of the display apparatus (shot image). Therefore, the display size of a marker is duly determined to be no smaller than the minimum size in a shot image. Therefore, the display apparatus may be controlled to display a marker in a sufficiently large size until the marker is detected and to reduce the display size of the marker in a single step rather than stepwise once the marker has been detected.

(8) According to yet another aspect of the present invention pertaining to the marker display control device, the marker-display-mode changing unit may repeatedly instruct the display apparatus to reduce the display size of the marker until the marker is no longer detectable and to increase the display size of the marker once the marker has failed to be detected.

According to this aspect, even if the minimum size is not determined, the display size of a marker is reduced stepwise.

(9) According to yet another aspect of the present invention pertaining to the marker display control device, the marker-display-mode changing unit may specify a marker color to be used by each display apparatus. The marker detecting unit may detect as a marker any pixel group appearing, in the shot image, in a specified color and a size no smaller than a predetermined minimum size.

(10) According to yet another aspect of the present invention, the marker display control device may further include: a coordinate conversion unit operable to convert coordinates describing a point on a shot image of a screen displayed on one of the display apparatuses into coordinates describing a point on the display area of the display apparatus. The marker detecting unit may at least detect a position of a marker on the shot image. The coordinate conversion unit may at least perform the coordinate conversion based on the detected position of the marker.

According to this aspect, an operation device into which the marker display control device is incorporated is made usable as an input device of the display apparatus to remotely operate the display apparatus. Therefore, the display apparatus is remotely controlled by making intuitive operations.

To make such remote operations, for example, the marker display control device first controls the display apparatus to display an operation menu and then displays a shot image of the operation menu on the display unit of the operation device, so that the user is allowed to operate the image of the operation menu presented on the display unit. In this example, the position of the display apparatus appearing in images sequentially shot is expected to be unsteady due to camera shake or user's motion. Therefore, it is preferable to continually detect the marker to accurately detect the position of the display apparatus.

The coordinate conversion unit may perform the coordinate conversion based on the positions of a plurality of markers or alternatively on the position of one marker and the display size of the marker.

(11) According to yet another aspect of the present invention pertaining to the marker display control device, the display apparatus may have a function of displaying, on the display area, a screen in which a marker and an operation menu appear. In response to designation of coordinates of a point on the shot image, the coordinate conversion unit may convert the designated coordinates into coordinates of a corresponding point on the display area of the display apparatus.

(12) According to yet another aspect of the present invention, the marker display control device may be incorporated into an operation device having: a display unit displaying the shot image of the screen displayed on the display apparatus; and an operation input unit for receiving an input designating coordinates of an arbitrary point on the display unit. The display apparatus may have a function of displaying, on the display area, a screen with a marker and an operation menu. The coordinate conversion unit may convert the coordinates designated by the input received on the operation input unit into coordinates of a corresponding point on the display area.

(13) According to yet another aspect of the present invention, the marker display control device may further include: a coordinate conversion unit operable to convert coordinates describing a point on a shot image of a display screen of one of the display apparatuses to coordinates describing a point on the display area of the display apparatus; and a position calculating unit operable to calculate, based on an amount of change in the display position of the marker and the display position of the marker as appeared in the shot image after the change, the display position of the marker before the change. The marker detecting unit may detect the position of the marker as appeared in the shot image. The coordinate conversion unit may perform the coordinate conversion based on a position of one or more markers not in the predetermined state and the calculated position of the marker in the predetermined state before the change.

With this aspect, even if the display position of a marker is changed, the marker display control device is capable of calculating a position at which the marker before the position change would appear in the shot image. Consequently, the coordinate conversion is performed in the same manner even if the display position of the marker is changed.

(14) According to one aspect of the present invention, an integrated circuit is for controlling one or more display apparatuses connected thereto via a communications unit, so that each display apparatus displays a marker to be used for recognizing the display apparatus. The integrated circuit includes: a marker detecting unit operable to detect a marker from a shot image of a display screen of one of the display apparatuses, the marker to be used for recognizing the display apparatus; and a marker-display-mode changing unit operable to instruct, based on a result of the marker detection, the display apparatus displaying the marker to change a display mode of the marker.

(15) According to yet another aspect of the present invention, a marker display control method is for controlling a display apparatus to display a marker used for recognizing the display apparatus. The marker display control method includes the steps of: acquiring a shot image of a display screen of the display apparatus; detecting the marker from the shot image; and instructing the display apparatus displaying the marker to change a display mode of the marker.

The following describes embodiments of the present invention, with reference to the drawings.

### Embodiment 1

The following describes a marker display control device according to Embodiment 1 of the present invention, an operation device into which the marker display control device is incorporated, and a display device.

In Embodiment 1, a portable information terminal equipped with a camera is described as an example of the operation device and a television as an example of the display device. The television displays a marker on a display screen (which may be also referred to as “display area”), and the portable information terminal shoots and detects an image of the marker to adjust the display size of the marker.

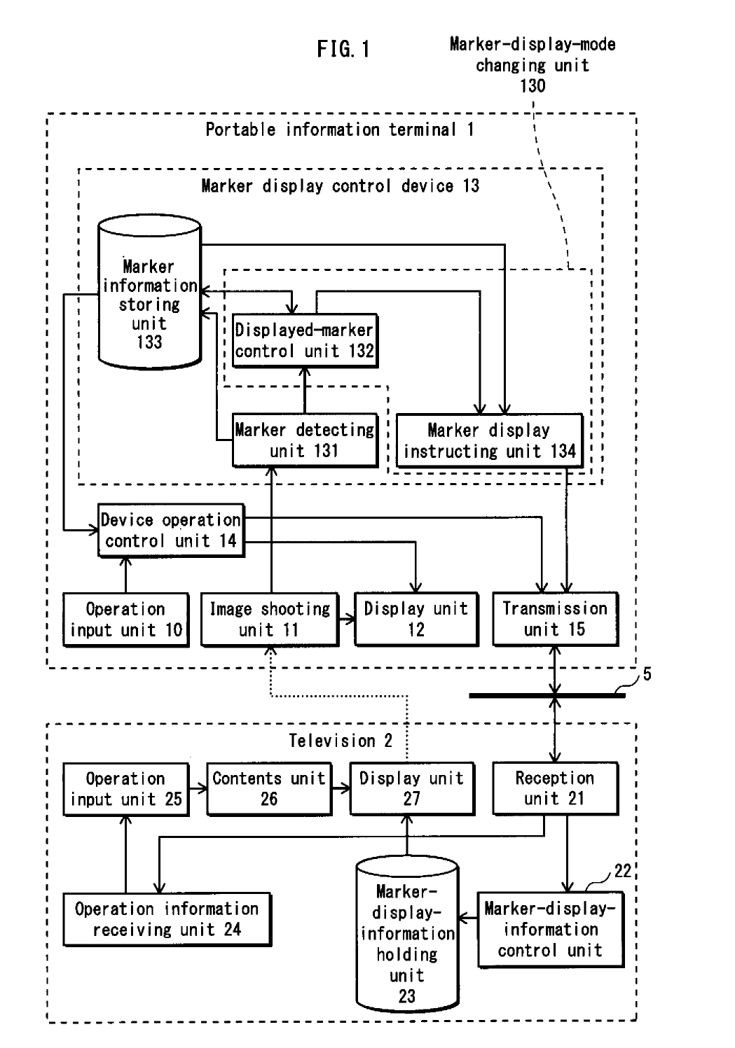

FIG. 1 is a block diagram schematically showing important components of a portable information terminal 1 and a television 2 (or personal computer 3) which is to be operated by the portable information terminal 1. Note that a marker display control device 13 according to Embodiment 1 of the present invention is incorporated into the portable information terminal 1. Examples of the portable information terminal 1 include a compact PC (personal computer), a mobile phone, a portable music player all equipped with a camera. The portable information terminal 1 is provided with a marker display control device and components for controlling a display device recognized as an operation target. The above configuration allows the display device photographed by the camera of the portable information terminal 1 to be processed on the portable information terminal 1. In addition, the display device may be a television, personal computer (hereinafter, referred to as “PC”), a liquid crystal projector or the like and has components for displaying markers. With the above configuration, the portable information terminal 1 is enabled to specify the type and position of the display device. Note that the display device is one example of a display apparatus.

### <Operation Device>

First, the configuration of the portable information terminal 1 acting as an operation device is described.

The portable information terminal 1 has an operation input unit 10, an image shooting unit 11 (which may be also referred to as “camera unit” 11), a display unit 12, the marker display control device 13, a device operation control unit 14, and a transmission unit 15 (which is an example of communications unit).

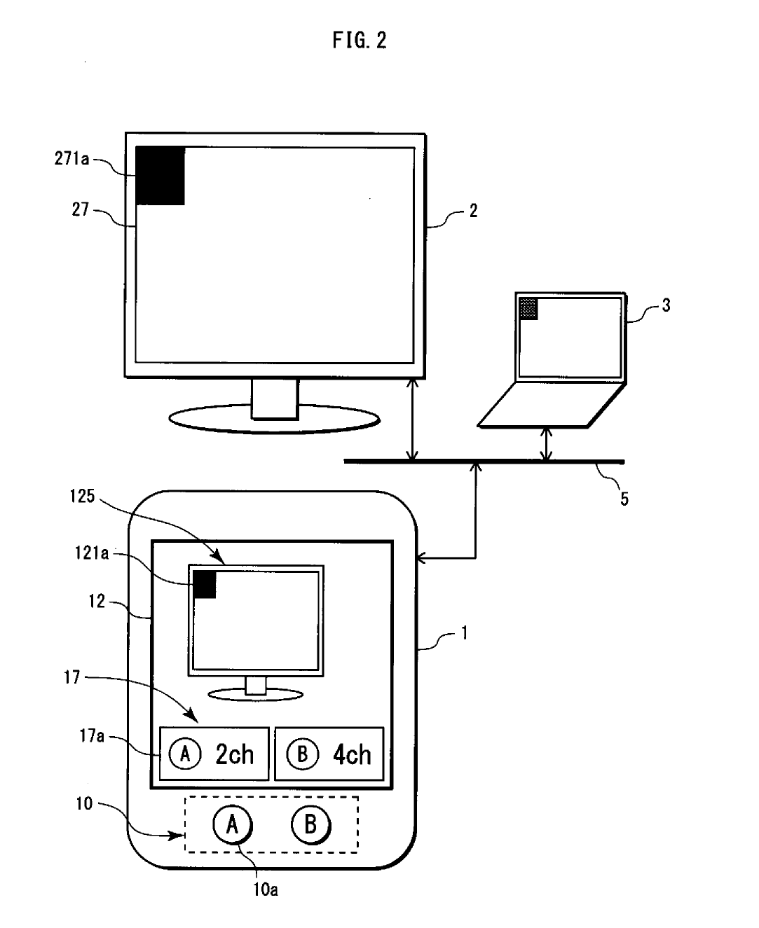

The operation input unit 10 has an input device such as a keyboard, button switches, touchpad, touch panel, etc. Upon receiving a user operation, the operation input unit 10 transmits information indicative of the received user operation to the device operation control unit 14. In the example shown in FIG. 2, the operation input unit 10 is provided with a button switch 10a and other switches.

The image shooting unit 11 is composed of a digital camera or the like. In addition, the image shooting unit 11 takes an image of a real world under an instruction given by the marker display control device 13 and encodes the shot image to generate information representing the shot image. Note that the image shooting unit 11 sequentially performs the image shooting and image data generation, several to several tens of times per second and outputs the resulting image information to the display unit 12 and a marker detecting unit 131.

Note that the shot image information mentioned herein may be in any of a variety of formats. In one example, the present embodiment adopts the bitmap format, which represents an image as two dimensional array P(x, y) of pieces of color information for a series of coordinates (x, y). In the bitmap format, each piece of color information may be expressed with RGB888, for example. Here, RGB888 refers to a method of representing color information with a set of 8-bit brightness values separately representing red, green and blue components. In the following description, the brightness value of the red component is denoted as Pr(x, y), the brightness value of the blue component is denoted as Pb(x, y), and the brightness value of the green component is expressed as Pg(x, y). In addition, the two dimensional array P(x, y) represents pieces of color information at a series of coordinates (x, y) and each piece of color information at respective set of x-y coordinates is referred to as a “pixel”.

The display unit 12 has a display panel such as a liquid crystal panel, an organic EL panel, or the like and also has a display controller for controlling the display panel to display images, such as figures, characters, and scenery to be presented by the portable information terminal 1 to the user. In the present embodiment, the display unit 12 displays a shot image that is reproduced based on the shot image information, etc. generated by the image shooting unit 11 (i.e., to display a so-called preview image).

The marker display control device 13 has a marker detecting unit 131, a displayed-marker control unit 132, the marker information storing unit 133, and a marker display instructing unit 134. In addition, the marker display control device 13 implements the functions of the components mentioned above by a microcomputer executing predetermined programs. Note that the marker display control device 13 is realized in an integrated circuit. Here, the marker display control device 13 may be configured without the marker information storing unit 133.

A marker-display-mode changing unit 130 has the displayed-marker control unit 132 and the marker display instructing unit 134.

The marker detecting unit 131 receives shot image information from the image shooting unit 11 and detects any marker contained in the shot image information. The marker detecting unit 133 writes marker information indicating each detected marker into the marker information storing unit 133 and notifies the displayed-marker control unit 132 that the marker information has been updated. Note that the details of marker information will be given later.

The displayed-marker control unit 132 fetches marker information from the marker information storing unit 133. Based on the size of the marker detected by the marker detecting unit 131, the displayed-marker control unit 132 reduces the marker size to the extent that the marker remains detectable, and writes the marker information back to the marker information storing unit 133. In addition, the displayed-marker control unit 132 requests the marker display instructing unit 134 to issue an instruction regarding the marker display to the television 2 currently displaying the detected marker.

The marker information storing unit 133 is a memory area (storage area) reserved in a storage unit having RAM, non-volatile memory (e.g., flash EEPROM) or the like and holds marker information.

The marker information includes information for identifying a marker, information indicating a display device associated with the marker, and information indicating a designated size of the marker. Information for identifying a marker indicates features relating to the shape of the marker. Based on this information, the marker contained in shot image information is made detectable.

Examples of information for identifying a marker include “marker color” and also include, in the case or two-dimensional marker, “marker shape” and “marker pattern”. In the present embodiment, the marker information storing unit 133 holds the “marker color” as information for identifying a marker (see FIG. 7). That is, the television 2 and the PC 3 are each associated with a marker of a different color to distinguish one from another. Note that the marker information storing unit 133 additionally holds, as information for identifying a marker, the minimum size (the minimum number of pixels Pm) of the marker appearing in shot image information (not shown).

Information indicating a display device associated with a marker relates to the display device that displays the marker. The name of the television 2 (see FIG. 7) and an IP address (not shown) are examples of such information.

The designated size of a marker is information indicating the size (display size) in which the marker is to be displayed on a display device.

In the present embodiment, the marker information further includes “marker detection information” obtained as a result of the marker detection. The marker detection information will be described later in detail. Briefly, the marker detection information includes, for example, a “detection flag”, “detected position” and “detected size” (FIG. 7).

In response to a request from the displayed-marker control unit 132, the marker display instructing unit 134 reads, from the marker information storing unit 133, a piece of marker information corresponding to the request to generate marker-display-instruction information and sends the resulting marker-display-instruction information to the transmission unit 15. The marker-display-instruction information is information generated by extracting, from the marker information, necessary information items for the display device to display the marker. The marker-display-instruction information includes both information for identifying a marker and the designated size of the marker.

When a marker is detected, the device operation control unit 14 identifies the display device to be operated, by using information held in the marker information storing unit 133. The device operation control unit 14 then displays, on the display unit 12, an operation menu 17 (see FIG. 2, for example) corresponding to the identified display device. When a user input of operating the operation menu is made on the operation input unit 10, the device operation control unit 14 sends operation information indicative of the user input to the transmission unit 15 for ultimately transmitting the operation information to the identified display device.

The transmission unit 15 transmits information received from the marker display instructing unit 134 and the device operation control unit 14 to a reception unit 21 of the television 2 using a communications unit 5 such as infrared communications or wireless LAN (Local Area Network). Here, in an example shown FIGS. 1 and 2, the communications unit 5 is a wireless LAN and the connections between the portable information terminal 1, the television 2, and the PC 3 is schematically illustrated.

More specifically, in the example shown in FIGS. 1 and 2, the communications unit 5 is composed of a base of a wireless LAN device. In contrast to the example shown in FIGS. 1 and 2, the communications unit may be construed to be composed of a base station of a wireless LAN device, the transmission unit 15 and the reception unit 21.

In addition, in the case where infrared communications is employed, the portable information terminal 1 and the television 2 are directly connected by the communications unit 5. In such a case, the communications unit is composed of the transmission unit 15 and the reception unit 21. Note that in the case where infrared communications is employed, it is not necessary that the portable information terminal 1 is connected to all display devices.

### <Display Device>

Next, components of the television 2, which is a display device, are described.

Although FIG. 1 only shows the components of the television 2 as an representative example, the PC 3 also has identical components.

The reception unit 21 receives information transmitted from the transmission unit 15 of the portable information terminal 1 by the communications unit 5, such as infrared communications, or a wireless LAN (or a wired LAN connected to a base of a wireless LAN device). If the received information contains marker-display-instruction information, the reception unit 21 sends the marker-display-instruction information to a marker-display-information control unit 22. On the other hand, if the received information contains operation information, the reception unit 21 sends the operation information to an operation information receiving unit 24.

The marker-display-information control unit 22 receives marker-display-instruction information that is transmitted based on a request from the marker display instructing unit 134 of the portable information terminal 1, and updates a marker-display-information holding unit 23 according to the received information.

The marker-display-information holding unit 23 is a memory area (storage area) reserved in a storage unit having RAM, non-volatile memory (e.g., flash EEPROM) or the like and holds marker display information. The marker display information is composed of information indicating whether a marker is displayed or not, information about the display mode (such as the color or display size of the marker) and the like. The marker display information is updated according to the marker-display-instruction information.

The operation information receiving unit 24 receives operation information that is transmitted based on a request from the device operation control unit 14 of the portable information terminal 1 and inputs the received operation information to the operation input unit 25.

The operation input unit 25 has an input device, such as a keyboard, button switches, touchpad, touch panel, etc. In addition, the operation input unit 25 also receives, as a user input, operation information input from the operation information receiving unit 24.

A contents unit 26 generates display information to be displayed on the display unit 27, based on information indicative of user operations received from the operation input unit 25 and also on contents information (not shown).

In the example in which the display device is the television 2, the contents unit has a tuner and a video processing circuit and generates display information based on contents information represented by a video signal of TV broadcasting or the like.

On the other hand, in the example in which the display device is the PC 3, the contents unit is considered to be part of the PC 3 that implements the functionality of a WEB browser, video player, music player, etc., by executing predetermined application software. Further, for example, by using the WEB browser function, the contents unit acquires contents information, which in this case is HTML data representing a WEB page via the Internet (not shown) according to user operations. The contents unit then determines the layout of display elements, such as images and buttons, based on the HTML data, generates display information by using the layout and display elements, and inputs the resulting display information to the display unit 27.

The display unit 27 has a display panel such as a liquid crystal panel, and a display controller for handling control to display images on the display panel. More specifically, the display controller controls to display, on the display panel, the display information generated by the contents unit 26. The display controller has an OSD (on-screen display) function. According to the marker display information held in the marker-display-information holding unit 23, the display controller operates to display a marker superimposed on a screen picture displayed according to the display information generated by the contents unit 26. In addition, the display controller can generate display information representing an operation menu used for setting-up the display device, according to user operations. Note that markers are displayed by priority over the display information generated by the contents unit 26. That is, in a region of the display area where a marker is displayed, a screen picture represented by the display information (which is the display contents primarily (i.e., originally) intended to be presented by the display apparatus) is not displayed. The screen picture presented based on the display information is a specific example of the “display contents primarily intended to be presented by the display apparatus”.

### <Operation>

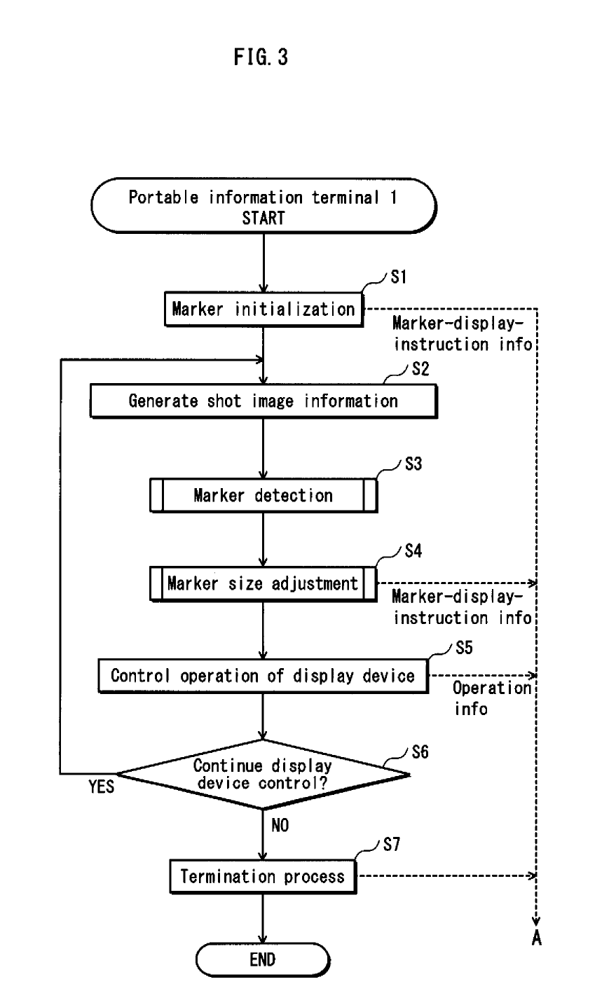

Next, the processing flow of a specific usage example (FIG. 2) according to Embodiment 1 of the present invention is described with reference to flowcharts shown in FIGS. 3, 4, 5, and 6.

FIG. 2 is a view showing the external representations of the portable information terminal 1, the television 2, and the PC 3 (personal computer 3) along with their relative dispositions. Note that the portable information terminal 1 is an operation device according to Embodiment 1 of the present invention, and the television 2 and the PC 3 are display devices according to Embodiment 1 of the present invention. FIG. 2 shows the state where the camera unit 11 (image shooting unit 11) of the portable information terminal 1 shoots an image of the television 2. Note that the portable information terminal 1 displays a shot image of the television 2 on the display unit 12 (to be more specific, on the display area or display screen of the display unit 12).

Note that a marker 271a is displayed on the display unit 27 (the display area or display screen of the display unit 27, to be more specific) of the television 2. Accordingly, in the image shot by the portable information terminal 1 (i.e., the display unit 12), a shot marker image 121a, which is a shot image of the marker 271a, appears. Note that the PC 3 does not appear in the shot image shown in FIG. 2 because the PC 3 is located outside the image shooting area of the portable information terminal 1.

Note that FIG. 2 shows the state where the operation menu 17 (including an operation item image 17a) is displayed by the device operation control unit 14 after the marker 271a is detected by the marker detecting unit 131.

In addition, the operation input unit 10 of the portable information terminal 1 has a plurality of button switches. A button switch 10a is used to receive a user input for selecting the operation item image 17a displayed on the display unit 12. That is, at a push of the button switch 10a, operation information associated with the operation item image 17a is sent to the transmission unit 15. Similarly, other button switches are associated with operation information or other operations.

The following now describes the processing performed by the portable information terminal 1 and the television 2 (or the PC 3).

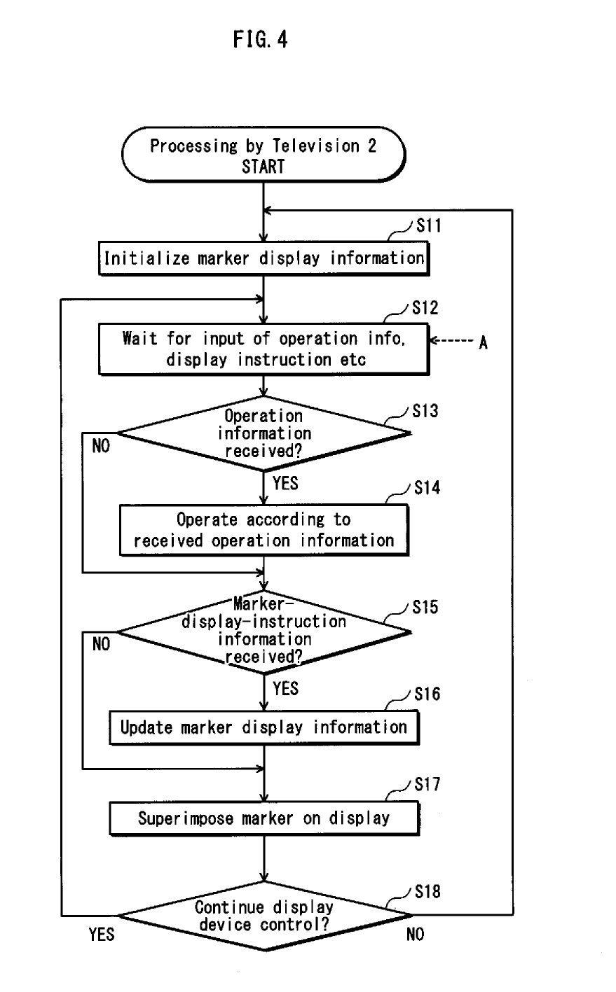

FIG. 3 is a flowchart showing a display-device-control process performed by the portable information terminal 1. FIG. 4 is a flowchart showing an instruction receiving process performed by the television 2 (or the PC 3).

### (1) Overview of Processing by Portable Information Terminal 1 (Operation Device)

The following describes the display-device-control process (Steps S1-S6) performed by the portable information terminal 1. Here, Steps S3 and S4 are described only briefly, and the detailed description thereof is given after the description of the processing by the television 2.

The user operates the portable information terminal 1 to start application software for performing the display-device-control process. Then, the user points the camera unit 11 (image shooting unit 11) at the television 2 and holds the portable information terminal 1 in place to keep the television 2 in a shot image displayed on the display unit 12 (FIG. 2).

In Step S1, the marker initialization process is performed to initialize the marker information storing unit 133 and to an issue marker display instruction to all the display devices (the television 2 and the PC 3 in this example).

The initialization of the marker information storing unit 133 is performed by the displayed-marker control unit 132.

FIG. 7 shows marker information held by the marker information storing unit 133 having been initialized. The following describes the marker information and the marker initialization process, with reference to FIG. 7.

In the marker initialization process, for each display device detectable by the portable information terminal 1 (i.e., registered with the portable information terminal 1), the following information is set: a “color” for identifying a corresponding display device and a “device name” of the corresponding display device. In this example, to make the television 2 and the PC 3 detectable, the device name “television” is set in association with the color “red”, whereas the device name “PC” is set in association with the color “blue”. Note that the default settings are made and stored in the storage unit of the portable information terminal 1 in advance (prior to the shipping or at the time of user registration, for example).

In the marker initialization process, marker information (i.e., marker detection information) obtained as a result of marker detection, namely “detection flag”, “detected position”, and “detected size”, is also initialized. A detection flag indicates whether or not a marker has been detected by the marker detecting unit. In the initial state, the detection flag indicates “not detected”. A detected position indicates the coordinates (Xd, Yd) of the position on the shot image at which the marker is detected by the marker detecting unit 131. Basically, a marker is not composed of a single pixel. Rather, a marker is detected as a group of a plurality of pixels. Therefore, the problem arises as to the coordinates of which of the pixels should be determined as the detected position. In the present embodiment, the coordinates of a top left pixel are used.

Note that the detected position is set to a valid value only when the detection flag holds a value indicating “detected”. At the time of the initialization process, the detection flag holds a value indicating “not detected” and thus the value of the detected position is set to indicate “not set”.

The detected size indicates the size of a marker composed of a plurality of pixels, and expressed as (Wd, Hd), where Wd denotes the width and Hr denotes the height. More specifically, the width Wd and the height Hd defines a quadrilateral (for example, rectangle) formed by the group of pixels of the marker, with the number of pixels present in the X axis direction and the number of pixels present in the Y axis direction.

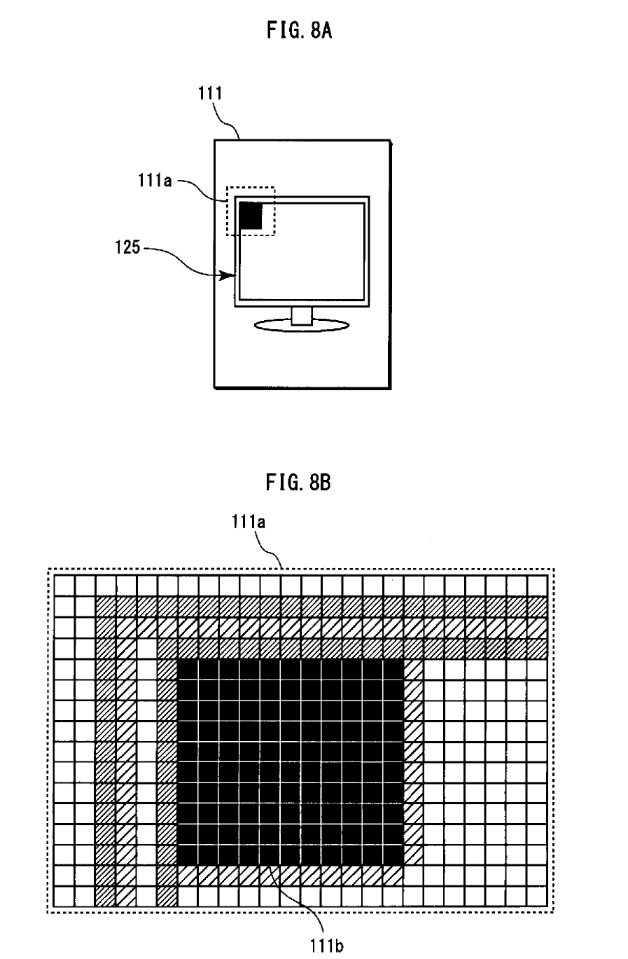

FIG. 8A is a view showing an example of a shot image 111, whereas FIG. 8B is a view showing an enlarged view of a region 111a. The region 111a shown in FIG. 8A is part of the shot image 111 in which the marker (pixel group 111) displayed on the television 2 appears. The region 111a is shown in enlargement. Each small square depicted inside the region 111a represents a pixel. In the regions 111a, the pixel group 111b filled in black is a region at which an image of a marker displayed on the television 2 appears (shot image of the marker). In this case, the detected size is determined as being (33, 30).

Note that the detected size is set to a valid value only when the detection flag holds a value indicating “detected”. At the time of the initialization process, the detection flag holds a value indicating “not detected”, the value of the detected size is set to indicate “not set”.

The designated size indicates a size in which the marker is to be displayed on a corresponding display device. The designated size is expressed as (Wr, Hr), where Wr denotes the width and Hr denotes the height Hr. Similarly to the detected size, the pixel group constituting a marker forms a rectangle, and the width Wr and the height Hr indicate the number of pixels in the X axis direction and Y axis direction of the rectangle, respectively. In this example, the initial values of a designated size are Wr=150 and Hr=150 for both the “television” and “PC”.

The initial value of the designated size is set relatively large in order to ensure markers to be detected even if the distance between the portable information terminal 1 and the television 2 is relatively long.

In Step S1, a marker display instruction is given to all the display devices, by transmitting the marker information set in the above initialization process to the television 2 and the PC 3 as marker-display-instruction information via the communications unit 5. Note in FIG. 3, the transmission of marker-display-instruction information is schematically shown with broken lines. The transmission of marker-display-instruction information continues from the reference sign “A” shown in FIG. 3 to the reference sign “A” shown in FIG. 4. The same description applies to the illustration of the transmission of another marker-display-instruction information (S4) and the transmission of operation information (S5).

In the case where three or more display devices are registered in the marker information storing unit 133, the marker-display-instruction information is transmitted to all of the three or more display devices in Step S1. That is, the marker-display-instruction information is transmitted to all the display devices registered in the marker information storing unit 133. With this arrangement, an instruction to display a marker is duly given to each display device, even before any marker detection.

Note that the marker-display-instruction information in this example is composed of information indication the “color” and “designated size”. That is, in this example, the marker-display-instruction information to be transmitted to the television 2 indicates the color “red” and the designation size of (150, 150), whereas the marker-display-instruction information to be transmitted to the PC 3 indicates the color “blue” and the designation size of (150, 150).

In Step S2, the image shooting unit 11 (camera unit 11) shoots an image of the television 2 to generate shot image information and inputs the thus generated shot image information to the marker detecting unit 131. In addition, the image shooting unit 11 also inputs the shot image information to the display unit 12. Note that the display unit 12 reproduces a shot image from the received shot image information and displays the shot image. Step S2 described above and Steps S3-S6 described below are repeated several to several tens of times per second. As a result, the display unit 12 displays moving images of real-world scenes shot by the image shooting unit 11 at the frame rate of several to several tens of frames per second.

In the marker detection process performed in Step S3, the marker detecting unit 131 performs the process of detecting a marker appearing in the shot image information and the process of updating the marker information. When any marker is detected, the marker detecting unit 131 acquires marker detection information, such as the detected size of the marker. The marker detecting unit 131 then writes the acquired marker detection information to the marker information storing unit 133, thereby updating the marker information held in the marker information storing unit 133.

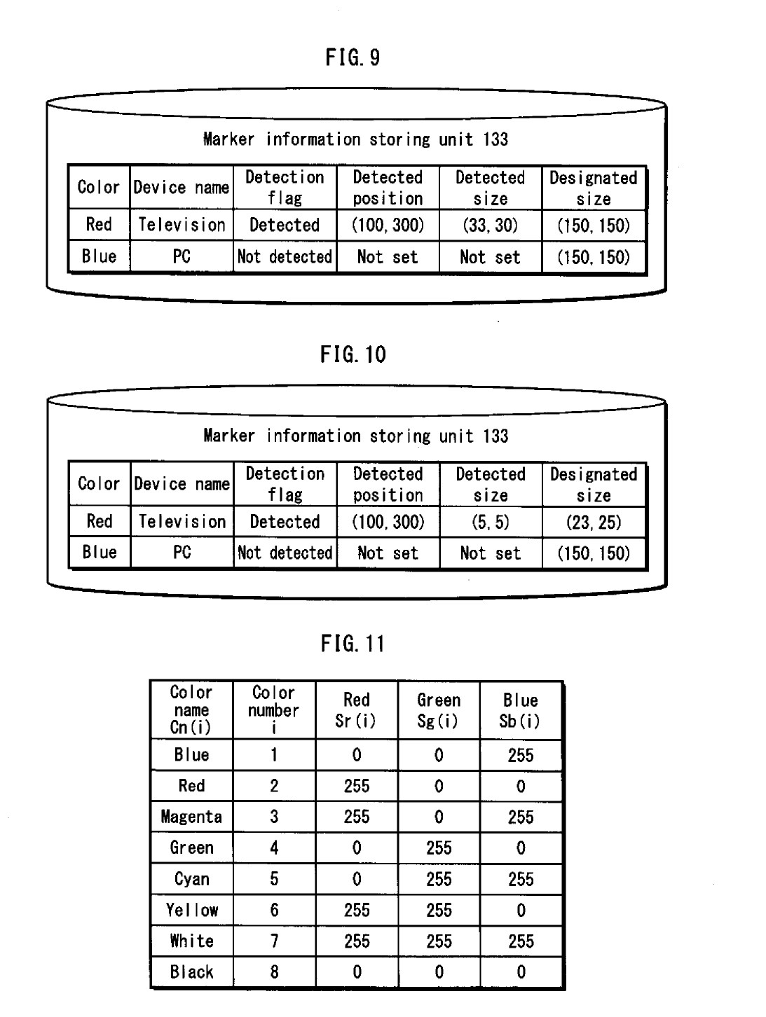

FIG. 9 is a table showing an example of the stored contents of the marker information storing unit 133 (i.e., the marker information held in the marker information storing unit 133) after the marker detection. In the example shown in FIG. 9, the marker displayed on the television 2 has been detected and thus the detection flag is set to indicate “detected” and the detected position and detected size are set accordingly.

In the marker-size-adjustment process performed in Step S4, the displayed-marker control unit 132 updates the marker information to reduce the designated size of the marker based on the detected size of the marker and other information. Then, the marker display instructing unit 134 generates a new piece of marker-display-instruction information, which includes the reduced designated size, and transmits the new piece of marker-display-instruction information to the television 2.

FIG. 10 is a table showing an example of the stored contents of the marker information storing unit 133 after the marker-size-adjustment process is performed in Step S4. As compared with the designated size (150, 150) shown in FIG. 9, the designated size shown in FIG. 10 is reduced to (23, 25) as a result of the marker-size-adjustment process. In the example shown in FIG. 10, in addition, the detected size is set to (5, 5), which is the value obtained by shooting and detecting an image of a marker displayed in the reduced designated size (23, 25).

In the operation receiving process performed in Step S5, a display device to be operated by the user is selected, the operation menu 17 is displayed, a user operation is received, and information indicative of a received user operation is transmitted.

More specifically, the device operation control unit 14 selects a display device to be operated by the user, based on the information regarding the marker detected in Step S3. Then, the device operation control unit 14 displays an operation menu 17 associated with the selected display device on the display unit 12, and waits for a user operation to be made. Upon receipt of a user operation made on the operation input unit 10 regarding the operation menu 17, the device operation control unit 14 sends operation information indicative of the received user operation to the selected display device via the transmission unit 15.

The following describes the processing performed in Step S5 in more details by way of example. In the example, the marker information storing unit 133 holds information regarding the display devices shown in FIG. 2, and the stored contents of the marker information storing unit 133 are as shown in FIG. 10 as a result of update performed in Step S4.

First, a description is given of the process of selecting a display device as an operation target.

The device operation control unit 14 selects a target display device, which is a display device to which operation information indicative of a user operation is to be transmitted. The selection is made based on the marker information held in the marker information storing unit 133. In this example, with reference to the marker information, a display device associated with a detection flag set to a value indicating “detected” is selected as a target display device, so that the operation information is to be transmitted to the selected target display device. That is, if the contents of the marker information storing unit 133 are as shown in FIG. 9, a detection flag indicating “detected” is associated with the device name “television”, so that the television 2 is selected as the target display device.

Note that there may be a case where more than one detection flag holds a value indicating “detected”. In such a case, a menu for selecting one of such display devices may be presented on the display unit 12 for prompting a user to enter a selection. In this case, the marker information storing unit 133 may additionally hold information indicating whether or not the individual display devices have been selected by the user. In this case, the target display device is determined according to the user input.

Next, a description is given of the process of displaying an operation menu and the process of receiving a user input.

The portable information terminal 1 has a storage unit (not shown) storing image information representing operation menus for the respective display devices. After selecting a target display device as an operation target, the device operation control unit 14 fetches a piece of image information representing an operation menu corresponding to the selected target display device, and sends the fetched piece of image information to the display unit 12 together with a display instruction for displaying the operation menu. As a result, an appropriate operation menu 17 is displayed.

After displaying the operation menu 17, the device operation control unit 14 receives a user input from the operation input unit 10. In this description, it is assumed that the user pushes the button switch 10a. In the state where the operation menu 17 is displayed, a push of the button switch 10a is associated with operation information indicating, as the operation item image 17a shows, an operation for changing a channel of broadcast program to 2ch. Thus, the operation to be made in response to the received user input is to change the broadcast program channel to “2ch”, as appearing in the displayed operation item image 17a.

The device operation control unit 14 then requests the transmission unit 15 to “transmit information indicative of the user operation to the target display device”. In this example, the operation information indicative of a request to “change the channel to 2ch” is transmitted to the television 2.

In the event that no user input is made for a predetermined time period, no operation information is transmitted in S5 and the processing moves onto Step S6.

In this example, Step S5 is performed in synchronism with the marker detection process in Step S3 and the marker-size-adjustment process in Step S4. Yet, Step S5 may be performed asynchronously with Steps S3 and S4.

Note, in addition, that although the operation menu 17 described above relates to a channel operation, various other menus may be displayed. For example, a menu with options relating to audio volume control or input switching may be displayed. With such a menu, the user is allowed to sequentially make operations to change the channel, adjust the audio volume, and so on.

Steps S2 to S5 are repeated until the display-device-control process ends (Step S6).

The display-device-control process ends when the application software that executes the control process is terminated in response, for example, to a user operation. In this case, in the termination process performed in Step S7, a command to end the marker display is issued to all the display devices (including the television 2), so that all the display devices ends the marker display.

In another example, the display-device-control process may be terminated or suspended when a predetermined time period has passed without any further user operation, after the last user operation of changing the channel, for example. Note that the state of being suspended refers to the state where the display-device-control process is stopped until a resume operation is received. During the suspension of the control process, the marker remains displayed on the television 2.

(2) Processing by Display devices

The following now describes the processing performed by the television 2.

FIG. 4 is a flowchart showing the processing performed by the television 2 (or by the PC 3) in response to marker-display-instruction information and other information transmitted from the portable information terminal 1. Although FIG. 4 only shows the processing performed by the television 2 as a representative example, the PC 3 also performs identical processing.

In Step S11, the marker-display-information control unit 22 initializes the stored contents (not shown) of the marker-display-information holding unit 23. The marker display information at least includes “display flag”, “color” and “designated size”. The “display flag” is information indicating whether or not to display a marker. Regarding the “color” and “designated size”, the same description that described in Step S1 applies here.

In the initialization process, the display flag is set to indicate “non-display” and the “color” and “designated size” to indicate “not set”.

In Step S12, the reception unit 21 waits for input, such as marker-display-instruction information and operation information, transmitted from the transmission unit 15 of the portable information terminal 1 (i.e., input represented by the reference sign “A” shown in FIG. 3).

If the input received by the reception unit 21 is operation information (Step S13), the operating state of the display device is changed according to the received operation information (Step S14). The following is a more specific description.

The operation information received by the reception unit 21 is input to the operation information receiving unit 24. The operation information receiving unit 24 converts the operation information into a user operation event used in the television 2 and inputs the user operation event to the operation input unit 25. The operation input unit 25 inputs the received user operation event to the contents unit 26. The contents unit 26 operates according to the received event to generate display information. In this example, the television 2 receives a signal indicative of the operation to change the channel to “2ch”, as described above in relation to Step S4. The television 2 then changes the channel to “2ch” and generates display information for presenting the broadcast program on the channel. The display information is converted into images and sequentially displayed on the display unit 12, thereby the operation of changing the change is completed.

If the input received by the reception unit 21 in Step S12 is marker-display-instruction information (Step S15), the marker display information is updated (Step S16). The following is a more specific description.

The marker-display-instruction information received by the reception unit is input to the marker-display-information control unit 22. The marker-display-information control unit 22 updates the stored contents of the marker-display-information holding unit 23 according to the received marker-display-instruction information. In this example, the television 2 performs the update in accordance with the marker-display-instruction information transmitted in Step S1, so that the color is changed to “red” and the designated size is changed to (150, 150). Similarly, the PC 3 performs the update so that the color is changed to “blue” and the designated size is changed to (150, 150). In addition, upon receipt of the information, the value of the display flag is changed to indicate “display”.

Note that the portable information terminal 1 performs Step S1 described above only once and thus marker-display-instruction information is transmitted to the display device only once. In contrast, Step 4 (details thereof will be described later) is repeated a plurality of times and marker-display-instruction information may be transmitted a plurality of times as necessary. Thus, the updating may be performed a plurality of times.

In the present embodiment, the television 2 is set to display a quadrilateral marker of the designated size. Alternatively, however, the television 2 may display a marker of a shape specified by the portable information terminal 1.

In Step S17, the display unit 27 displays the marker superimposed on the display information generated by the contents unit 26. Here, the superimposed marker is displayed according to the stored contents of the marker-display-information holding unit 23. That is, if the display flag of the marker display information indicates “display”, the display unit 27 renders a marker on the image information being displayed, according to the color and designated size indicated in the marker display information. In this example, the television 2 renders a red square of 150 pixels wide by 150 pixels high on the display information being displayed, whereas the PC 3 renders a blue square of 150 pixels wide by 150 pixels high on the display information being displayed. The rendering position of a marker is arbitrary determined as a fixed position in advance by each display device (for example, the coordinates (0, 0) are determined as the position of the top left pixel of a marker), so that the marker is displayed at the determined position. Alternatively, the designation of the display position may be additionally included in marker display information, so that the marker is displayed at the designated position (this configuration will be described later in detail in Embodiment 3).

The processing described above is repeated at least during the time the display-device-control process performed by the portable information terminal 1 continues (Step S18). When a command to terminate the display-device-control process is received from the portable information terminal 1, the initialization process is performed in Step S11 to hide the marker display (marker display OFF). Then, the television 2 waits for input of a display instruction, for example (S12).

This concludes the description of the processing performed by the television 2.

### (3) Details of Marker Detection Process

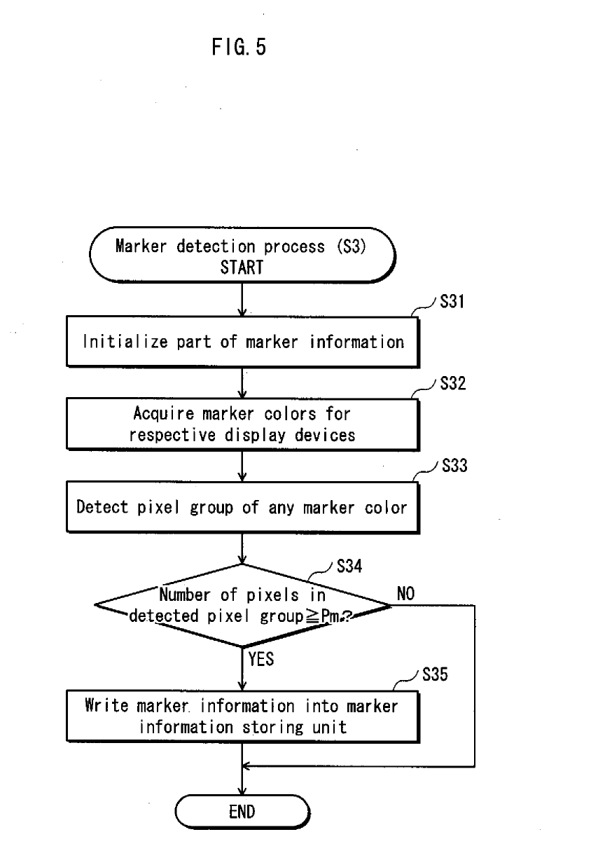

Next, the details of the marker detection process performed in Step S3 are described with reference to the flowchart shown in FIG. 5. In Step S3, the marker detecting unit 131 receives the shot image information generated by the image shooting unit 11 and detects a marker from the shot image information. In the following description, it is assumed that the shot image information generated by the image shooting unit 11 in Step S2 described above represents the shot image 111 shown in FIG. 8.

In Step S31, the marker information held in the marker information storing unit 133 is partially initialized. More specifically, the marker information held in the marker information storing unit 133 is initialized, so that all the detection flags for the respective display devices are reset to “not detected”. In addition, all the detected positions and detected sizes stored in the marker information are set to the values indicating “not set”.

In Step S32, the marker detecting unit 131 reads the marker color assigned to each display device from the marker information storing unit 133. In this example, the marker detecting unit 131 acquires “red” for the television 2 and “blue” for the PC 3, as shown in FIG. 7.

In Step S33, the marker detecting unit 131 searches the shot image information for any pixel group of the color matching one of the colors read in Step S32, namely, “red” and “blue”. The detection of a pixel group of each color is carried out in the following manner, based on the color information of each pixel P(x, y).

First, for each pixel P(x, y), the sum of the brightness differences of the respective color components RGB (red, green and blue) relative to corresponding color components of a reference color (see FIG. 11) is calculated in the following equation. Hereinafter, the sum is simply referred to as “brightness difference sum” C(i).

C(i)=|Pᵣ(x,y)−Sᵣ(i)|+|P_{g}(x,y)−S_{g}(i)|+|P_{b}(x,y)−S_{b}(i)| [Equation 1]

Here, Pr(x, y), Pg(x, y), and Pb(x, y) denote the brightness values of red, green, and blue components of the pixel, respectively. In addition, the reference brightness values Sr(i), Sg(i) and Sb(i) are the brightness values of the color components constituting a reference color. FIG. 11 is a view showing example settings of the reference brightness values. Here, the letter “i” denotes a color number. For example, in the case of the color red, the color number “i” is 2, and the reference brightness values of the respective color components are Sr(2)=255, Sg(2)=0, and Sb(2)=0. Note that the reference brightness values of the respective reference colors are stored in the storage unit of the portable information terminal 1.

Then, for each pixel contained in the shot image information, the brightness difference sums C(i) is calculated with respect to a corresponding reference color having the color number i (where 1≦i≦N). In the example of FIG. 11, N=8, so that eight brightness difference sums C(1)−C(8) are calculated for each pixel. Then, for each pixel, the smallest one of the eight brightness difference sums C(1)−C(8) is selected as C(i₀) Then, the color name Cn(i₀), which corresponds to the color number i₀ of the smallest brightness difference sum Cn(i₀), is determined as the color of the pixel.

Further, if a plurality of pixels having the same color are contiguously arranged, the pixels are recognized as a pixel group. More specifically, if one or more of pixels P(xₖ−1, yₖ), P(xₖ+1, yₖ), P(xₖ, yₖ−1), and P(xₖ, yₖ+1) are determined as having the same color as the P(xₖ, yₖ), the pixels having the same color (naturally, the pixel P(xₖ, yₖ) is included) are recognized as a pixel group. Here, the subscript “k” denotes, for example, a positive integer, so that P(xₖ, yₖ) represents the color of a pixel at the k^{th} point on the x and y coordinates.

In this example, the shot image information 111 includes a portion 111b in which a shot image of a marker displayed on the television 2 appears. Each pixel in this portion 111b should be determined as having the brightness values close to “red”. Consequently, in Step S33, the region 111b is detected as a pixel group having the color “red”. Note that the brightness values of the respective color components of a color determined to be “red” may slightly deviate from the corresponding reference brightness values (the reference brightness of red Sr(2)=255, green Sg(2)=0, and blue Sb(2)=0), depending on the photosensitivity or image shooting environment of the image shooting unit 11.

Here, in determining the color of each pixel, the upper limit may be set to the value of C(i), which ensures that the closest reference color is selected as the color of the pixel. In this case, in the event that the brightness difference sums C(1)−C(N) all exceed the upper limit value, the color of the pixel is left “not set” (which is indicated by the color number “0”, for example). With this arrangement, if the brightness value of any pixel is determined as greatly deviating from the reference color, such a pixel is excluded from any further processing for marker detection. In other words, what is detectable in the marker detection is a pixel group composed exclusively of pixels having the smallest one of the brightness difference sums C(1)−C(N) equal to or less than the upper limit. In this way, the accuracy of the marker detention is improved.

In addition, in detecting a pixel group, if one or more of pixels P(xₖ−1, yₖ), P(xₖ+1, yₖ), P(xₖ, yₖ−1) and P(xₖ, yₖ+1) and one or more of pixels P(xₖ−1, yₖ−1), P(xₖ+1, yₖ−1), P(xₖ−1, yₖ+1), and P(xₖ+1, yₖ+1) have the same color as the pixel P(xₖ, yₖ), then pixels having the same color (naturally, the pixel P(xₖ, yₖ) is included) are recognized as forming a pixel group. In addition, instead of “one or more pixels”, the minimum of N pixels (where N≧2) may be determined as forming a pixel group. In this case, the resistance to noise increases with the value N. At the same time, however, the risk also increases that a marker which should be detected is disregarded as noise.

In Step S34, it is determined whether or not the pixel group detected in Step S33 is a marker. More specifically, the determination is made based on whether the number of pixels contained in the pixel group is equal to the minimum number Pm or greater. That is, if the pixel number is less than the minimum number Pm, the pixel group is determined as noise rather than a marker. Note that the minimum number Pm is calculated by Equation 2 shown below and the smallest possible number of the minimum number Pm is “1”

Pₘ=α×Wₚ×Hₚ [Equation 2]

Here, the value of Wp denotes the number of pixels present in the lateral direction, whereas the value of Hp denotes the number of pixels present in the vertical direction. Both the values Wp and Hp are set to a smallest detectable size of a marker. In the present embodiment, the values of Wp and Hp are both set to “5”.

In addition, the coefficient α is set to a value greater than “0” and equal to “1” or less. The reliability to detect a marker increases with a decrease of the coefficient α. At the same time, however, the risk of erroneously detecting a noise as a marker increases because a smaller coefficient α makes a small pixel group to be more easily detected as a marker. On the other hand, although a larger coefficient α reduces the risk of such detection error, the risk increases that a small marker is discarded as noise. Therefore, in order to reduce the risk of detection error, the coefficient α may preferably be equal to 0.5 or greater. Yet, in the situation where detection error is unlikely, the coefficient α may be set to less than 0.5.

The coefficient α is determined based, for example, on the performance specifications of the camera unit 11 (image shooting unit 11), such as resolutions. Suppose that the resolution of the camera unit 11 is relatively low. In this case, even if a marker is displayed on the television 2 in the size calculated in Step S33 (described below), the marker appearing in an image shot by the camera unit 11 may be smaller than the calculated size. In preparation for such a case, the coefficient α may preferably be a small value to some extent, such as 0.6.

The coefficient α may be determined by conducting image shooting tests, prior to shipment or at the time of executing application software that is for controlling a display device.

By multiplying each of the pixel numbers Wp and Hp by the coefficient α, the pixel numbers (α·Wp and α·Hp) defining the minimum size of a detectable marker (the smallest size that is necessary for the marker to be detected) are calculated.

Instead of the minimum number Pm, the criteria for determining a pixel group as a marker may be such that the number of pixels in the lateral direction (X axis direction) and the vertical direction (Y axis direction) are both equal to or greater than the respective setting values (α·Wp and α·Hp). This arrangement reduces the risk of marker detection error, provided that a marker has a quadrilateral shape, as in this example.

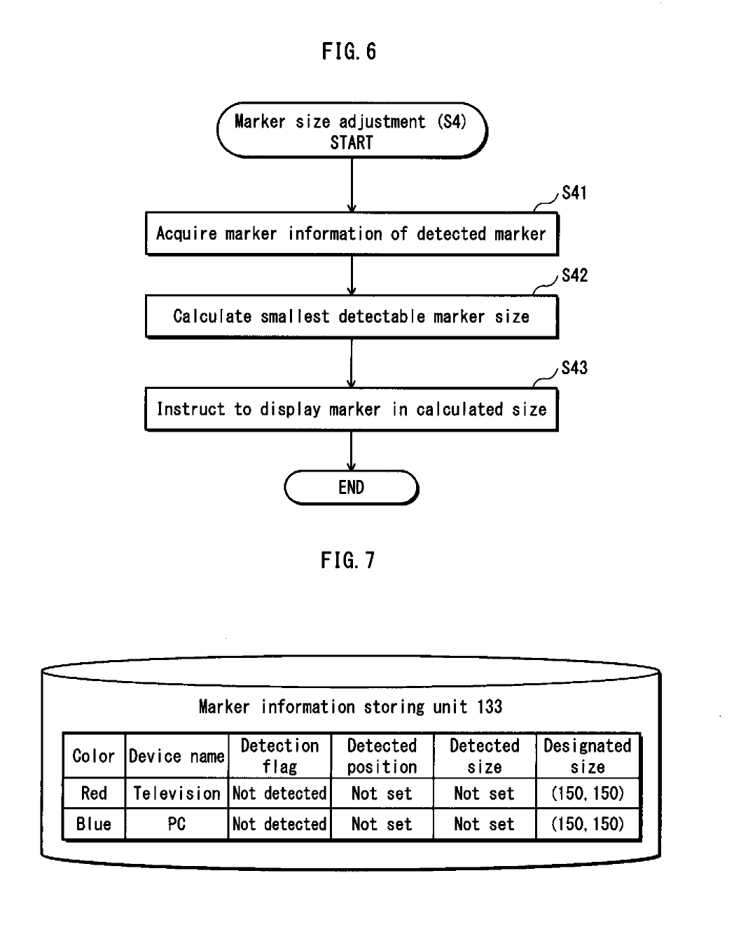

In Step S35, the marker information regarding the pixel group determined as a marker in Step S34 is written into the marker information storing unit 133. More specifically, information written in this step is the detected position and detected size of the pixel group. In addition, the detection flag is changed to the value indicating “detected”. Through the process in this step, the stored contents of the marker information storing unit 133 is updated. As a result, the stored contents as shown in FIG. 6 are changed to FIG. 9, for example.

### (4) Marker-Size-Adjustment Process

FIG. 6 is a flowchart showing a marker-size-adjustment process performed in Step S4. With reference to the figure, the marker-size-adjustment process is described.

In Step S41, the displayed-marker control unit 132 fetches, from the marker information storing unit 133, marker information relating to a display device associated with the detected marker, i.e., marker information having a detection flag set to indicate “detected”. In this example, a piece of marker information relating to the television 2 is solely fetched.

In Step S42, the displayed-marker control unit 132 calculates, based on the marker information fetched in Step S41, a display size that is smaller but still detectable by the marker detecting unit 131. Here, the reduced display size of the marker (Wm, Hm) is calculated by Equation 3 shown below. In the equation, Wp denotes a predetermined number of pixels of a detectable marker in the lateral direction, Hp denotes a predetermined number of pixels of the detectable marker in the vertical direction, (Wd, Hd) denotes the detected size of the marker, and (Ws, Hs) denotes the designated size of the marker.

$${W}_{m} = \frac{{W}_{p}}{{W}_{d}} \cdot {W}_{s } \\ {H}_{m} = \frac{{H}_{p}}{{H}_{d}} \cdot {H}_{s} \qquad [ Equation 3 ]$$

In this example, suppose that Wp=5 and Hp=5, so that the detected size is Wd=33 and Wd=30 and the designated size is Ws=150 and Ws=150. Thus, the reduced size is calculated to be Wm=22.72 and Hm=25. Here, the calculation result is rounded off to the nearest integer, so that the reduced size (Wm, Hm)=(23, 25) are calculated as a display size of a marker that is smaller but still detectable by the marker detecting unit 131. The designated size in the marker information is updated, with the newly calculated size (23, 25) (FIG. 10).

In Step S43, the designated size having been reduced is written into the marker information storing unit 133 and at the same time a marker display instruction is issued to the television 2. The marker display instructing unit 134 then transmits marker-display-instruction information to the television 2 corresponding to the marker of which designated size is updated in Step S42. In this example, the marker-display-instruction information indicates the color “red” and the designated size (23, 25). Upon receipt of the marker-display-instruction information transmitted in Step S43, the television 2 performs Steps S16 and S17 described above, so that the display size of the marker is changed to a size of 23 pixels wide by 25 pixels high.

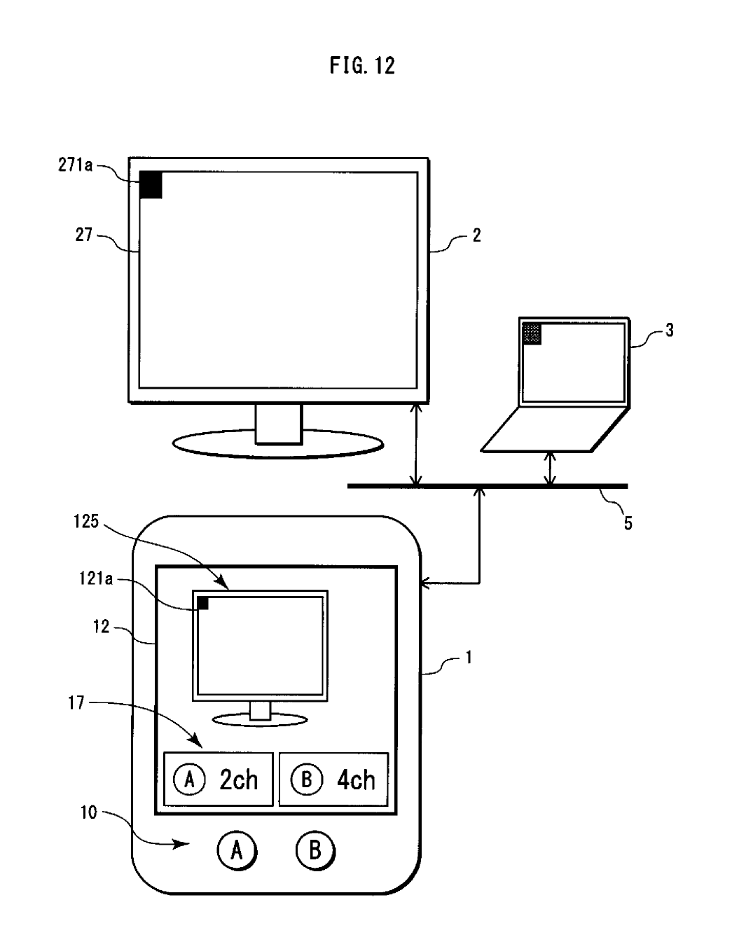

As a result, the relatively large size of the marker 271a displayed on the television 2 as shown in FIG. 2 is reduced as shown in FIG. 12. With this arrangement, the loss of viewability of the screen picture to be primarily presented on the television 2 is reduced.

Since the designated size of the marker 271a is calculated by Equation 3 described above, the size of the marker to be detected in the shot image information acquired in the next marker detection process will be (Wp, Hp), on condition that the positional relation between the portable information terminal 1 and the television 2 remains the same. Since the detected size of the pixel group is equal to or greater than the minimum number Pm, the pixel group is duly detected as a marker. As described above, the minimum number Pm is equal to the coefficient α×Wp×Hp (0<α≦1). In addition to determining the minimum number Pm in the above manner, the designated size is determined so that the marker in a shot image appears in the size (Wp, Hp). That is, the designated size determined in this way ensures that the marker is detected with nearly perfect reliability. It is therefore ensured that the designated size of a marker is reduced to a smallest detectable size.

Note that although the coefficient α is determined depending on the performance of the camera unit 11, the values of Wp and Hp do not depend on the performance of the camera unit 11. That is, since the designated size of a marker is calculated based on the set values Wp and Hp, the designated size is allowed to be determined without consideration of the resolution of the camera unit 11.

### (5) Recapitulation

As described above, Embodiment 1 realizes that the marker 271a initially displayed on the television 2 in a relatively large size as shown in FIG. 2 is changed to a smallest size detectable by the portable information terminal 1 as shown in FIG. 12.

With the above arrangement, although a marker displayed on the display device, such as the television 2, partially blocks the screen picture and thus interferes with viewing, the loss of viewability of the screen picture is reduced. At the same time, the marker detection is facilitated because the display size of a marker on the display device, such as a television, is reduced to the extent that the marker is still detectable. In addition, until the marker detection process is performed, the display size of a marker is kept relatively large, so that the marker is allowed to be detected relatively easily without being susceptible to the shooting distance. That is, without compromising the reliability in marker detection, the loss of viewability of the screen picture, which is the primary display contents to be presented on the display device, is reduced.

### <Shape of Marker and Supplemental Note>

In the present embodiment, the marker shape is not limited to a quadrilateral and may be a triangle, an L-shape (hook-shape), or a strip shape. Especially, the marker of right-angled triangle or L-shape ensures the effective use of the display screen, by displaying the marker at a location that the right angled portion of the marker coincides with a corner of the display screen.

In addition, the marker is initially displayed according to the marker-display-instruction information transmitted to the television 2 etc., in the marker initialization process (S1) and then reduced in size after the marker detection process. Thus, the initial display size of the marker may be made significantly large. For example, the marker may be displayed in size equal to the entire display screen (display area) of the display device or in a frame shape along the outer peripheral edge of the display screen. The above arrangement facilitates the initial marker detection.

In addition, one marker does not have to be in a single color and may be in multiple colors. For example, a marker is divided into two or three portions, so that two or more colors are assigned to the single marker. In the case where a single marker is displayed in multiple colors, it is highly likely that adjacent pixel groups found to have colors of a predetermined combination constitute a marker. Thus, the accuracy of marker detection improves. In addition, one marker may be composed of a first portion of a first color and a second portion of a second color disposed to surround the first color. Such a marker is also effective to improve the marker detection accuracy. In addition, since the first color portion is partitioned by the second color portion from the contents displayed on the television 2 etc., the outline of the first portion of the marker is accurately reproduced in a shot image, which is advantageous for pattern matching.

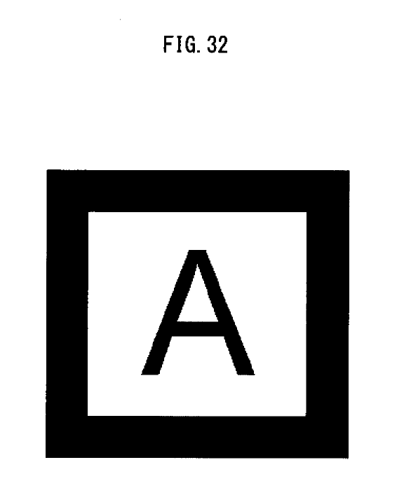

In yet another example, the marker may be a symbol enclosed in a frame as shown in FIG. 32. Note the specific symbol shown in the frame is one example of pattern of a marker.

In addition, the number of markers is not limited to one and more than one markers may be simultaneously displayed. For example, two markers may be displayed at two diagonally opposing corners of the display screen of the display device.

### [Modification 1]

In the above embodiment, the color of the marker is set in advance.

Alternatively, a modification may be made to include a process of selecting a marker color to be displayed on a display device from colors not included in the current piece of shot image information (i.e., unused colors).

### <Unused-Color Search-Process>

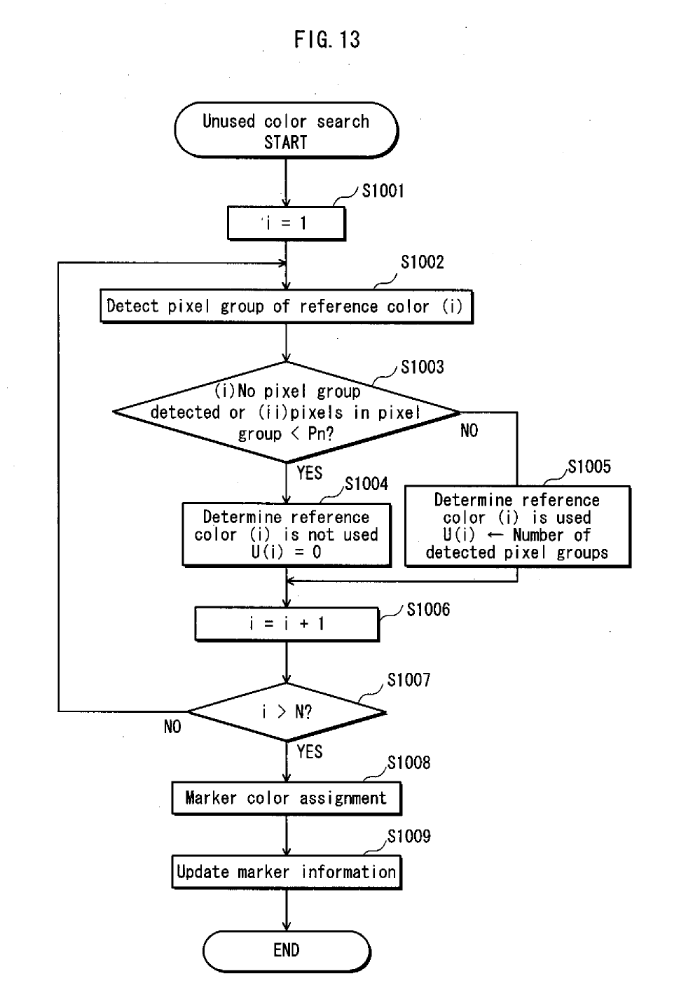

FIG. 13 is a flowchart of an unused-color search-process for searching colors not used in shot image information.

The unused-color search-process is conducted on shot image information obtained by shooting an image of the television 2 etc., not displaying a marker. Alternatively, the unused-color search-process may be conducted on shot image information from which markers exceeding the number of markers actually displayed are detected in the marker detection process.

First, in Step S1001, a variable i is set to “1”. In addition, U(i) is set to “0”.

In Steps S1002-S1007, for each of the reference colors identified by the color number 1-N (where N=8, for example), it is sequentially checked whether there is any pixel group composed of pixels equal in number to a threshold Pn or greater. Note that the threshold Pn is set to the value equal to the minimum number Pm or less.

In S1002, the same process as the marker detection process (S33) is performed to detect a pixel group.

In steps S1003-S1005, the following processing is performed. First, for the reference color (i) identified by the color number (i), if no pixel group is found, or every pixel group found is composed of a fewer number of pixels than the threshold Pn, it is then determined that the reference color (i) is not used. Therefore, the value “0” is assigned to the variable U(i) in S1004. On the other hand, if a pixel group composed of pixels equal in number to the threshold Pn or greater, it is then determined that the reference color(i) is in use. Consequently, the number of pixel groups is assigned to the variable U(i).

After checking each of N reference colors, an unused color is assigned to the marker in Step S1008. Here, an unused color is selected from reference colors(i) each having the variable U(i)=0.

In Step S1009, the marker information for the respective display devices is updated to set the thus selected unused color as the marker color.

When the portable information terminal 1 transmits the marker-display-instruction information having been updated to the television 2 etc., in Step S1 or S3 (FIG. 3), the television 2 displays the marker with the assigned color (FIG. 4, Steps S15-S17). The marker displayed in such a color is easily detected.

As described above, by shooting an image of the television 2 etc., to conduct the unused-color search-process, a marker is set to be displayed on the television 2 in a color not used in the shot image information. Thus, the marker is easily detectable.

In Steps S1002 and S1003, it may be sufficient to simply determine whether or not there is a pixel of the same color as each reference color. Then, a reference color determined not included in the shot image information is assigned as the marker color to be displayed on, the television 2 etc., so that the accuracy of the marker detection is improved. In the manner described above, by causing the respective display devices to display a marker in a color not appearing in shot image information, Step S34 may be omitted as the color does not appear anywhere else but the marker.

In addition, it is not required to perform Steps S1002-S1007 for all the reference colors. For example, it is sufficient that as many unused colors as the number of registered display devices are detected. In addition, in the case of erroneous marker detection, it is not necessary to check the color of such an erroneously detected marker.

### <Example of Unused-Color Search-Process at Erroneous Marker Detection>

Here, the following describes how the marker detection process (Step S3) is performed in the case where the number of markers detected is greater than the number of markers displayed. In the following description, the marker detection process according to Embodiment 1 is denoted as “marker detection process 1”, whereas the marker detection process according to this modification is denoted as “marker detection process 2” for distinction.

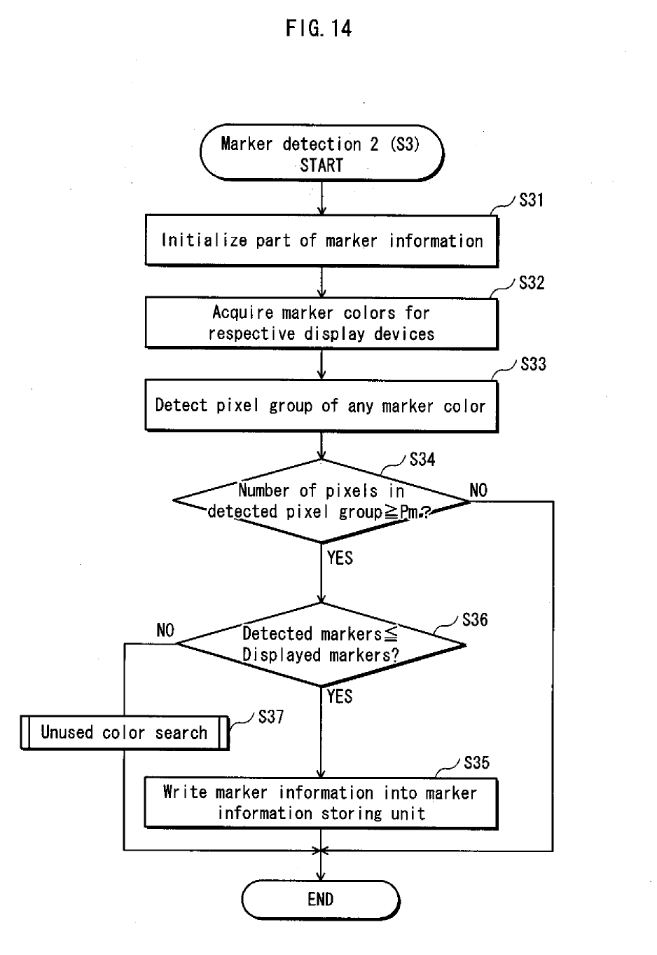

FIG. 14 is a flowchart of the marker detection process 2. In this figure, Steps S31-S35 are the same as the corresponding steps of the marker detection process 1, so that a description thereof is omitted.

In Step S36, it is checked whether the numbers of marker detected, i.e., the number of pixel groups each determined as a marker (i.e., the number of pixels included is equal to or greater than Pm), exceeds the number of markers actually displayed (one, in the case of Embodiment 1). The number of markers to be displayed is specified by the portable information terminal 1 and stored in the portable information terminal 1.

If the number of markers detected exceeds the number of markers displayed, it means that an image other than a marker is detected as a marker by error. To address the error, the unused-color search-process described above is performed in Step S37, so that the marker color assigned for each display device is changed.

Note that the unused-color search-process may be performed before the marker initialization process (Step S1 shown in FIG. 3). In this case, an image of the television 2 etc., is shot with the no marker displayed state in response to a user operation and the shot image information acquired by the image shooting is used for the unused-color search-process. Then, the marker color assigned to each display device through the unused-color search-process is stored to the marker information storing unit 133 in the marker initialization process (Step S1) and transmitted as the marker-display-instruction information to the television 2 etc.

In addition, in Step S1002 of the unused-color search-process described above, an additional step may be performed for detecting a pixel or a pixel group which results in that the brightness difference sum C(i) is equal to or less than a threshold. In this case, it is preferable to detect in the marker detection process a pixel group which results in the brightness difference sum C(i) that is equal to or less than the threshold.

Here, in the event of erroneous marker detection, the marker color may be changed without conducting the unused-color search-process. That is, the marker color is changed repeatedly until no erroneous detection occurs. As a consequence, an unused color is assigned as a marker color in the end.

### [Modification 2]

Embodiment 1 may be modified to perform the following processing.

In Step S34 of the marker detection process, a pixel group detected in Step S33 is subject to pattern matching to determine whether or not the pixel group is a marker. In the pattern matching, data about the marker shape is compared against the feature quantity of the shape of the pixel group. If the difference with the feature quantity is equal to a predetermined value of smaller, the pixel group is determined as a marker. Consequently, a pixel group having a shape not similar to the marker shape is determined as not being a marker, even if the color of the pixel group is the same as the marker.

By performing the pattern matching, the accuracy of the marker detection is improved.

### [Modification 3]

In the above embodiment, the brightness difference sum C(i) is calculated in the marker detection process. Alternatively to calculating the brightness difference sum C(i), it is an option to determine whether the color of a pixel matches a reference color depending on whether the brightness conditions for the reference color are satisfied.

For example, when the reference color is “red”, the brightness thresholds Br(2), Bg(2), and Bb(2) for the respective colors of RGB are set. Then, by detecting any pixels satisfying that the red brightness value Pr(x, y) is equal to or greater than Br(2), the green brightness value Pg(x, y) is equal to or smaller than Bg(2), and the blue brightness value Pb(x, y) is smaller than equal to Bb(2), pixels having the same color as the marker are extracted. In one example, the brightness threshold Br(2) may be set at 200 and the brightness thresholds Bg(2) and Bb(2) may be set at 30. In the example shown in FIG. 11, for a color component with the reference brightness value set at 255, the brightness threshold is used as the lower limit, whereas for a color component with the reference brightness value set at 0, the brightness threshold value is used as the upper limit.

According to this modification, it is not necessary to acquire the colors of all the pixels. Rather, it is sufficient to extract pixels having the same color as the marker. In this way, the marker detection process is simplified.

### Embodiment 2

This embodiment ensures a marker to be detected by increasing the display size of the marker, in the even that the marker detection fails due to, for example, increase in distance between the portable information terminal and e.g., the television.

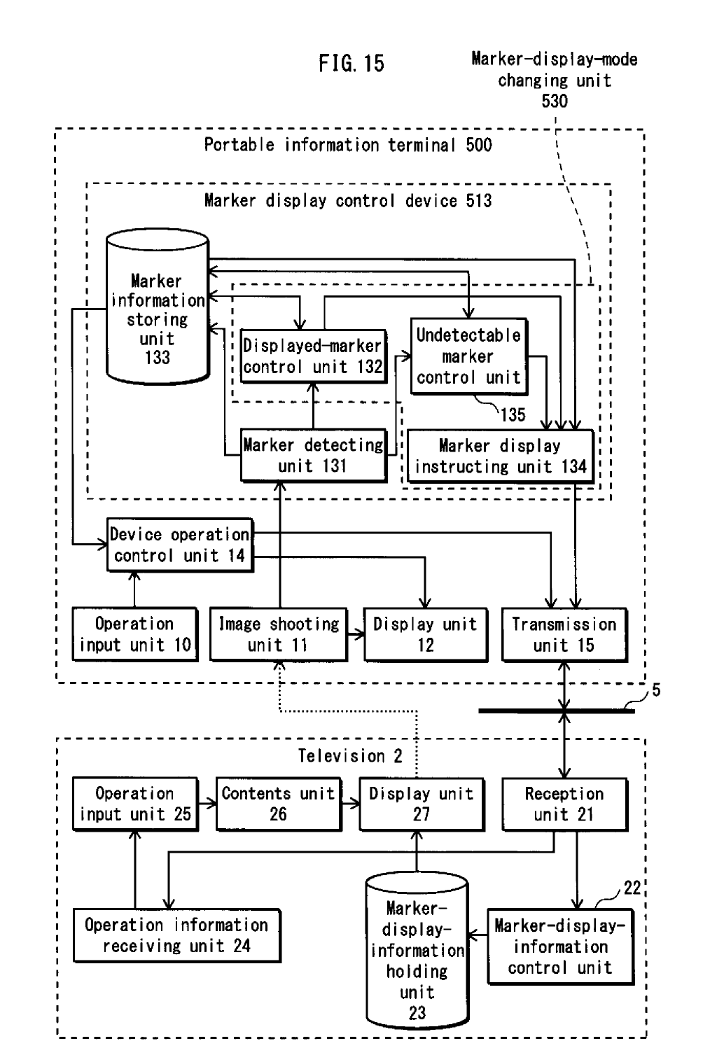

FIG. 15 is a block diagram showing the structure of a portable information terminal 500 into which a marker display control device according to Embodiment 2 of the present invention is incorporated, and also the structure of the television 2. Here, the portable information terminal 500 acts as an operation device, whereas the television 2 acts as a display device to be operated with the use of the operation device. Note that the PC 3 has an identical structure to the television 2. In FIG. 15, the reference signs shown in FIG. 1 are used to denote the same or identical components to those of Embodiment 1 and a description thereof is omitted or simplified. Note, however, components denoted by the reference signs used in FIG. 1 may have an additional function not provided in the corresponding components shown in FIG. 1.

A marker display control device 513 shown in FIG. 15 includes an undetectable marker control unit 135, in addition to the same components as the marker display control device 13 shown in FIG. 1.

An undetectable marker refers to a marker that was detected in the previous detection (does not have to be immediately previous detection) but failed to be detected in the current marker detection.

The undetectable marker control unit 135 performs a process of increasing the display size of such an undetectable marker (i.e., a marker failed to be detected) to ensure the marker to be detectable again.

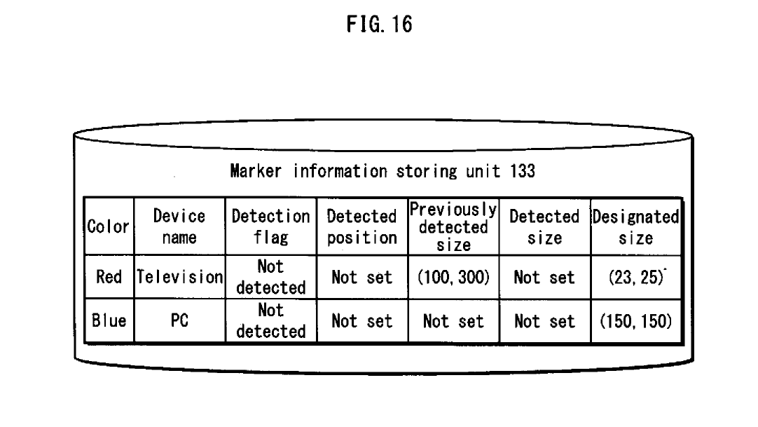

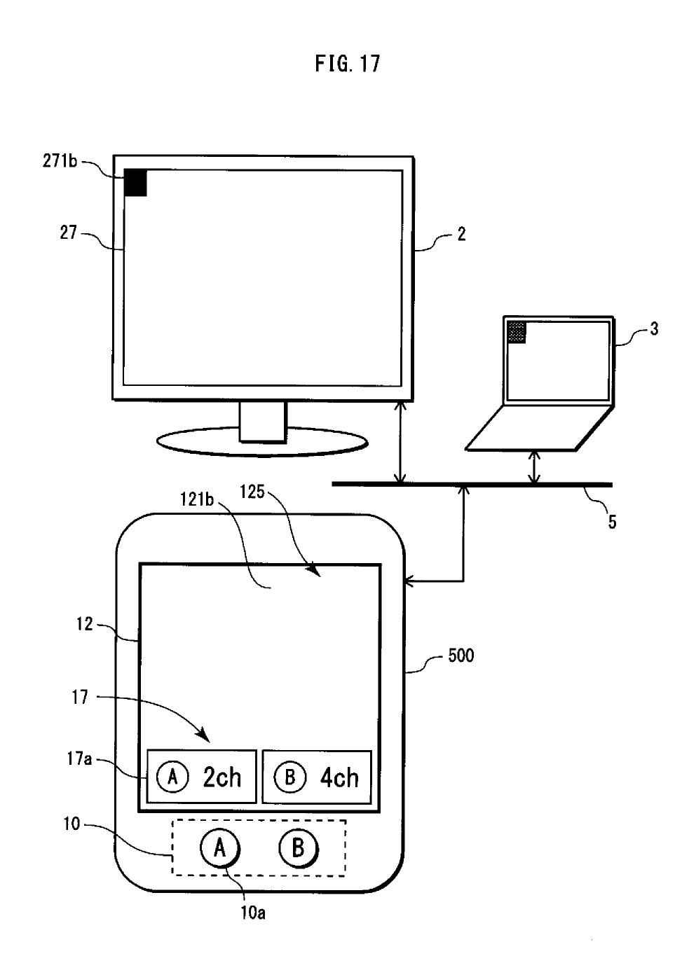

FIG. 16 shows the stored contents of the marker information storing unit 133 under the state shown in FIG. 17. The marker information stored in the marker information storing unit 133 has an additional entry of “previously detected position” to recognize the presence of an undetectable marker. With this additional entry, any marker is recognized an undetectable marker, if the previously detected position is set to a valid value but the detected position is not set to any valid value (or if the detection flag is set to “not detected”).

FIG. 17 is a view showing external representations of an operation device (portable information terminal 500) and display devices (the television 2 and the PC 3) according to Embodiment 2 of the present invention, along with their relative dispositions. FIG. 17 is the state in which the portable information terminal 500 is moved away from the television 2, as compared with the state shown in FIG. 12. Therefore, in a shot image displayed on the portable information terminal 500, a portion corresponding to a marker 271b (this portion is referred to as a shot marker image 121b) appears as a pixel group having the number of pixels which falls short of the minimum number Pm to be detected as a marker. That is, in Step S34, the shot marker image 121a is detected as a marker in the state shown in FIG. 2, whereas the shot marker image 121b in the state shown in FIG. 17 is no longer detectable as a marker.

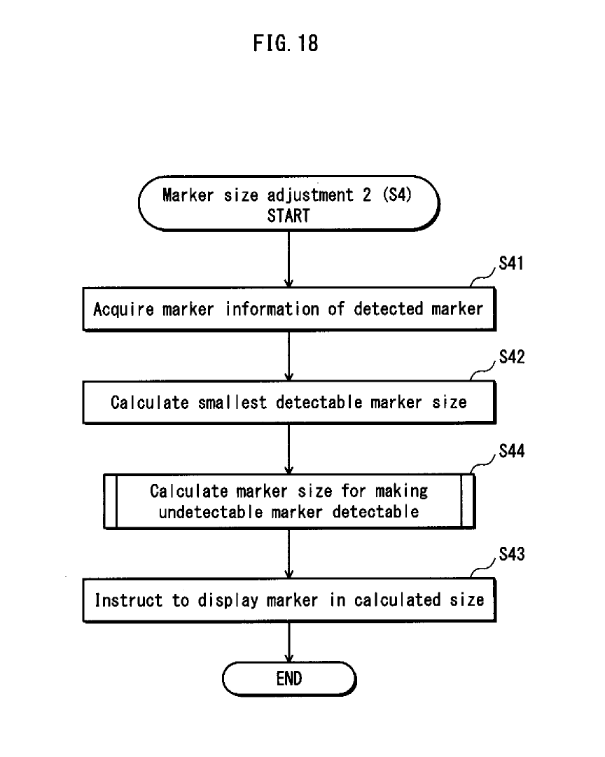

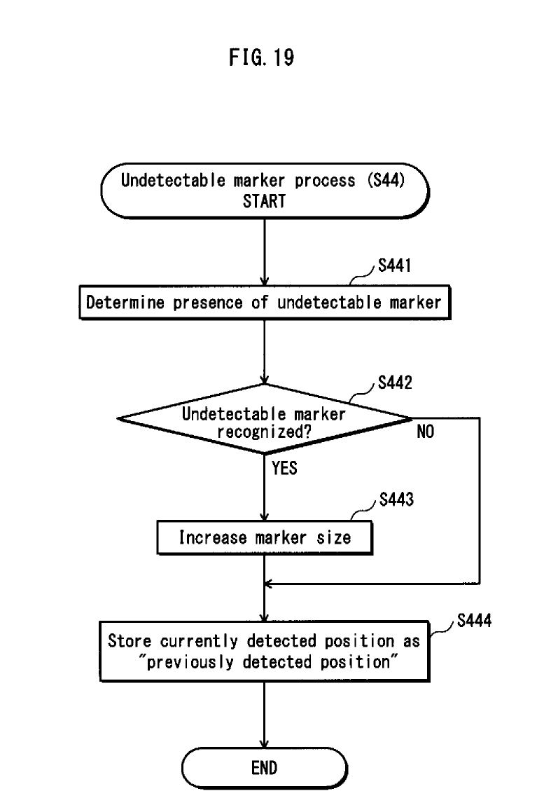

The processing performed by the portable information terminal 500 in the state shown in FIG. 17 is described with reference to the flowcharts shown in FIGS. 18 and 19. Note that the same steps as those already described with reference to FIG. 3 are denoted by the same reference signs and no further description is given here.

FIG. 18 is a flowchart showing a marker-size-adjustment process 2. The marker-size-adjustment process 2 includes Step S44 in addition to the marker-size-adjustment process (Step S4) of the Embodiment 1. In Step S44, the display mode of an undetectable marker is changed (hereinafter, referred to as “undetectable marker process”). Steps S41 and S42 are performed in the same manner as the Embodiment 1. In addition, when no marker is detected, Steps S41 and S42 are substantially not performed.

Since no marker associated with the television 2 is detected in the current marker detection process (S3), a corresponding piece of marker information shown in FIG. 16 is such that the detection flag indicates “not detected” and the detected position and detected size indicate “not set”. In addition, since a marker is successfully detected in the previous marker detection process, the previously detected position for the marker is set to a valid value.

In Step S44, the undetected marker control unit 135 performs the undetectable marker process according to the steps shown in FIG. 19. That is, if the presence of an undetectable marker is recognized, the undetected marker control unit 135 operates to increase the display size of the marker to makes it detectable.

In Step S441, the presence of any undetectable marker is determined. The presence of an undetectable marker is recognized when the following two conditions are satisfied. Condition 1 is that the marker information storing unit 133 includes a piece of marker information with the detected position indicating “not set”. It is because such a piece of marker information indicates that a corresponding marker is failed to be detected in the current marker detection process. Alternatively, that Condition 1 is satisfied if the detection flag indicates “not detected”. Condition 2 is that the previously detected position included in the same piece of marker information does not indicate “not set”. It is because such a piece of marker information indicates that the corresponding marker was detected at the indicated position in the previous marker detection process. In this example, as described with reference to FIG. 16, a marker for the television 2 is specified as an undetectable marker.

In addition, if no undetectable marker is specified in Step S441, Step S443 is not performed (Step S442).

In Step S443, the designated size of the marker specified as an undetectable marker is changed to a size (Wb and Hb) larger than the current size. More specifically, the designated size indicated in the corresponding piece of marker information is multiplied by a constant B, and the designated size held in the marker information storing unit 133 is updated with the multiplication result. In this example, suppose B=2, then Wb=23×2=46 and Hb=25×2=50. Thus, the designated size is changed to (46, 50).

Lastly, in Step S444, the value of the detected position of each piece of marker information is set as the previously detected position. As a result, the value of the “detected position” detected in the current marker detection process is now set as the value of the previously detected position to be used in the next undetectable marker process.

Note that when the value of “detected position” is not set, the value of the “previously detected position” is left unchanged. That is, in the case where the value of the “detected position” is not set, where as the previously detected position is set to a valid value defining some coordinates, the coordinates remain unchanged.

Through this process, the designated size is changed to a larger size and the new designated size is transmitted in the marker-display-instruction information to the television 2 (Step S43). As a result, the display size of the marker on the television 2 is made larger (Steps S15-S17), which facilities the marker detection performed thereafter (Step S3).

With the addition of Step S44, the display size of the undetectable marker is successively made larger until the marker becomes detectable once again. After the marker becomes detectable once again, the marker size is reduced to a minimum detectable size through the steps described in Embodiment 1.

As described above, according to Embodiment 2, the marker display control device 513 controls the display device, such as the television 2, to increase the display size of a marker 271b, if the portable information terminal 500 fails to detect the marker 271b as a result, for example, of an increase in the distance between the portable information terminal 500 and the television 2. Consequently, the marker 271b is ensured to be detected.

That is, Embodiment 2 achieves to reduce the loss of viewability of the screen picture by reducing the display size of a marker. In addition, if the marker becomes undetectable due to, for example, an increase in the shooting distance, Embodiment 2 achieves to facilitates detection of the marker.

Note that the display device may fall outside an image shooting area as a result of the camera unit 11 of the portable information terminal 500 being turned to a different direction by a user. To address the risk, the following processing may be performed.

That is, in Step S443, an arrangement is made to keep the count of how many times the designated size of an undetectable marker is increased. Then, an additional step may be performed after Step S444 to determine if the count reaches a predetermined number without successfully detecting the marker. If so, it is determined, for example, that the television 2 is not included in the image shooting area and thus the undetectable marker process is terminated. Furthermore, another step may be added to terminate the undetectable marker process if the designated size of an undetectable marker exceeds a predetermined upper limit. The additional step mentioned above may be provided after Step S444.

At the time of terminating the process of changing the display mode of an undetectable marker, the “previously detected position” in the piece of marker information corresponding to the undetectable marker is changed to “not set”. As a result, the marker is no longer recognized as a undetectable marker. In addition, the display device on which an undetectable marker is displayed is given an instruction to terminate the display of the marker or to reduce the designated size of the marker. To issue an instruction to reduce the designated size, the portable information terminal 500 may retain in the marker information storing unit 133 the designated size that is stored before the undetectable marker is recognized. Then, the thus retained designated size is used in the instruction.

In the present embodiment, a marker-display-mode changing unit 530 is composed of the displayed-marker control unit 132, the marker information storing unit 133, the marker display instructing unit 134, and the undetectable marker control unit 135.

### [Modification 1]

Note that Embodiment 2 described above may be modified to adjust the display size of a marker back to a detectable size, in the event that the marker once detected becomes not detectable in the marker detection process that is performed while gradually reducing the display size.

More specifically, Embodiment 2 described above may be modified in the following manner.

In order to retain the detectable size of a marker, the marker information stored in the marker information storing unit 133 has an additional entry of “the previously designated size”. With this additional entry, if the marker detection fails as a result of reducing the designated size, the designated size is changed back to the previously designated size.

In Step S42, the designated size of a marker is reduced in stepwise by 10% or so, for example. In this example, the designated size is reduced from (150, 150) to (135, 135). In addition, before changing the designated size, the originally designated size, which is (150, 150) in this case, is copied to the previously designated size. The reduction of designated size is repeated until the marker is no longer detectable. Once the marker has been recognized as an undetectable marker, the designated size is changed back to the previously designated size in Step S443. As a result, the display size of a marker is reliably reduced to the smallest detectable size. Note that after the designated size of a marker is changed back to the previously designated size, the designated size is not reduced any further.

In addition, when increasing the designated size of an undetectable marker, the increment of the designated size may be made relatively smaller (1.1 times for example). With this arrangement, it is prevented that the marker is made excessively large, so that the loss of viewability of the screen picture of the display device is suppressed.

In Embodiment 2, in addition, each display device may display a plurality of markers. If more than one undetectable marker is recognized, the designated size of each of the thus recognized undetectable markers is increased in Step S44.

### Embodiment 3

In this embodiment, in the event that an image of the marker is not shot because the display position of the marker is inappropriate and thus, for example, the marker is blocked from line of sight by an obstruction, the display position of a marker is changed (that is, the marker is moved) to ensure the marker is detected once again.

In the present embodiment, in addition, an operation menu of the television 2 etc., is remotely controlled, by designating coordinates of a point on the display unit 12 (more specifically, on the display screen or display area of the display unit 12) of the portable information terminal 600 displaying the operation menu.

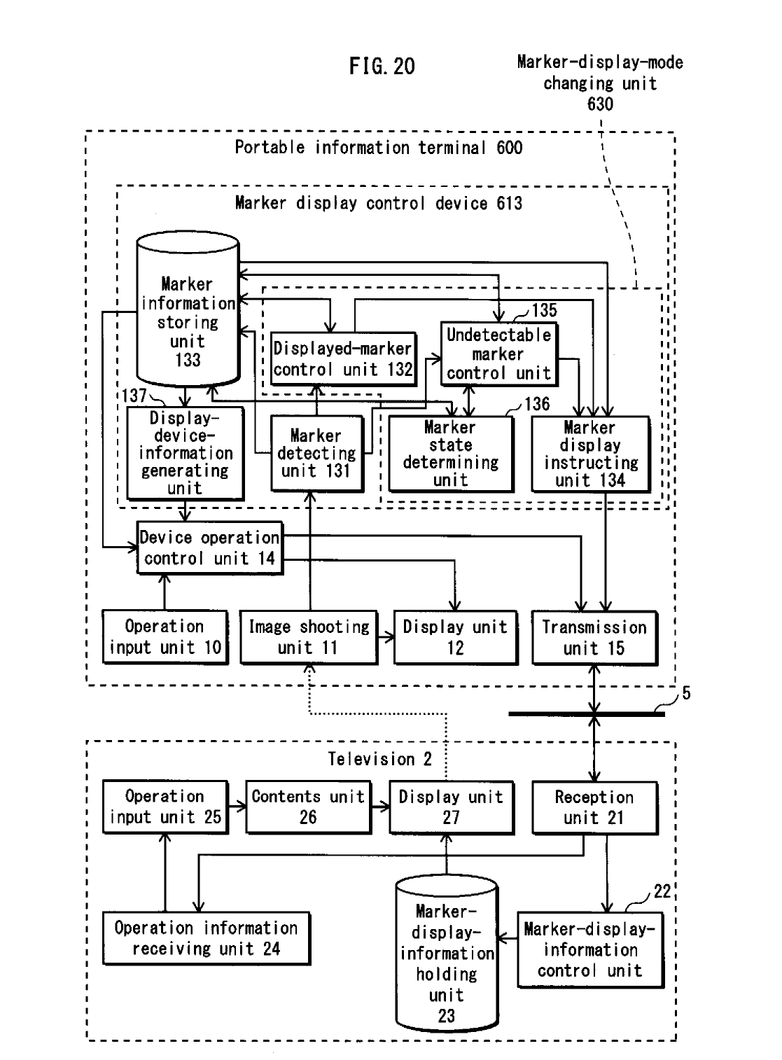

FIG. 20 is a view showing the structure of a portable information terminal 600 into which a marker display control device according to Embodiment 3 of the present invention is incorporated. FIG. 20 also shows the structure of the television 2 and the PC 3. The portable information terminal 600 acts as an operation device, whereas the television 2 and the PC 3 act as display device to be operated by the portable information terminal 600. In FIG. 20, the reference signs shown in FIGS. 1 and 15 are used to denote the same or identical components and a description thereof is omitted or simplified. Note, however, components denoted by the reference signs used in FIGS. 1 and 15 may have an additional function not provided in the corresponding components shown in FIGS. 1 and 15.

A marker display control device 613 shown in FIG. 20 includes a marker state determining unit 136 and a display-device-information generating unit 137, in addition to the same components as the marker display control device 513 shown in FIG. 15. More specifically, a marker-display-mode changing unit 630 includes the marker state determining unit 136 in addition to the same components as the marker-display-mode changing unit 530 shown in FIG. 15.

### <Regarding Remote Control Method>

### (1) Overview

First, a description is given of a method of remote control according to the present embodiment.

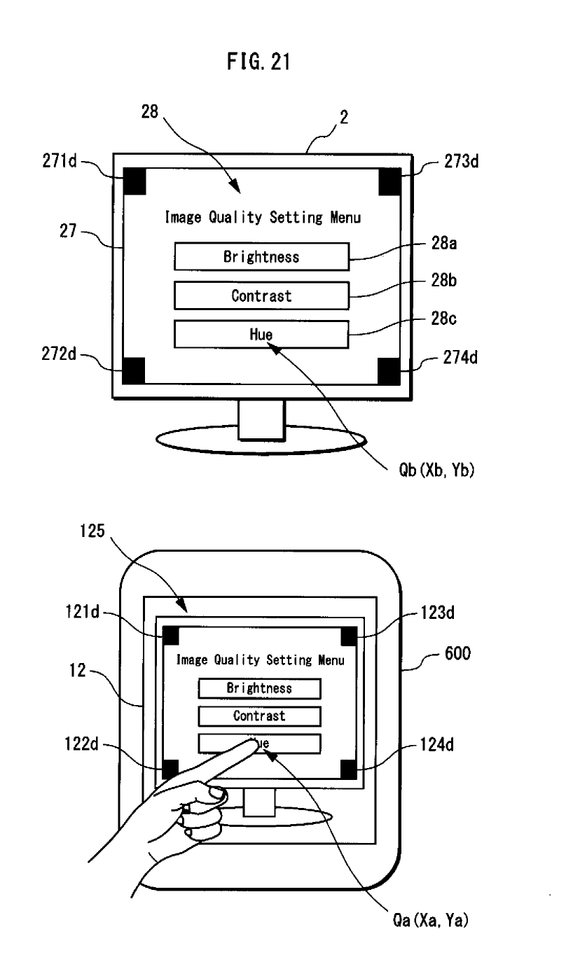

FIG. 21 is a view showing the television 2 and the portable information terminal 600. In the figure, the television 2 displays four markers 271d-274d and the operation menu 28, whereas the portable information terminal 600 has shot an image of the television 2.

The television 2 (as well as the PC 3) has a function of displaying the operation menu 28 used for image quality settings and the like. In the example shown in FIG. 21, the operation menu 28 includes three operation item images 28a, 28b, and 28c. Normally, one of the operation item images 28a, 28b, and 28c is selected on a remote control dedicated for the television to make the image quality settings.

The operation menu 28 is configured to be displayed in colors other the marker colors (in neutral colors, for example). This arrangement facilitates the marker detection. Note that information indicating the colors used for the operation menu 28 to be displayed on the respective display devices may be added to the marker information held in the marker information storing unit 133, so that the marker color is selected from colors other than the colors used for the operation menu 28.

The operation input unit 10 of the portable information terminal 600 is provided with a touchpad disposed to cover the liquid crystal panel of the display unit 12. In response to a user operation of touching the touchpad, coordinates Qa (Xa, Ya) of an arbitrary point on the display unit 12 are input. In short, the coordinates Qa(Xa, Ya) of a point on the display unit 12 are designated.

### (2) Generating Point Information Qb

The display-device-information generating unit 137 has a function of coordinate conversion to be performed in Step S5 described above. In the coordinate conversion, coordinates Qa(Xa, Ya) of a point in the shot image information at which the display device as appears are converted into coordinates Qb(Xb, Yb) of a corresponding point on the actual display area of the display device. The former coordinates may also be referred to as shot image coordinates Qa, whereas the latter coordinates may also be referred to as display area coordinates Qb.

In addition, the process of acquiring the display area coordinates Qb by converting the shot image coordinates Qa is referred to as the process of “generating point information Qb(Xb, Yb)”. The point information Qb(Xb, Yb) is information indicating the coordinates describing a point on the display area of a display device that correspond to the coordinates Qa(Xa, Ya) describing a point in a shot image at which the display device appears.

The process of generating the point information Qb(Xb, Yb) is described in detail with reference to FIG. 21. The display unit 12 shown in FIG. 21 simply displays the shot image as it is. As described above, the display unit 12 is provided with so-called a touch panel disposed to cover the liquid crystal panel and doubles as the operation input unit 10. That is, a user can specify a point Qa(Xa, Ya) on the shot image with a touch operation.

In response, the point information Qb(Xb, Yb) for the television 2 is calculated by Equation 4 shown below as an example. In Equation 4, Wa and Ha respectively denote the numbers of pixels included in the lateral and vertical directions in the display area of the television 2 as appeared in the shot image. On the other hand, Wb and Hb respectively denote the number of pixels included in the lateral and vertical directions in the actual display area of the television 2. Note that the numbers of pixels Wb and Hb equally mean the resolutions of the television 2 and are stored in the marker information storing unit 133.

$${W}_{a} = {X}_{4} - {X}_{1} \\ {H}_{a} = {Y}_{4} - {Y}_{1} \\ {X}_{b} = \frac{{W}_{b}}{{W}_{a}} \cdot ( {X}_{α} - {X}_{1} ) \\ {Y}_{b} = \frac{{H}_{b}}{{H}_{a}} \cdot ( {Y}_{α} - {Y}_{1} ) \qquad [ Equation 4 ]$$

In Equation 4 above, the X coordinates X₁ and X₄ and the Y coordinates Y₁ and Y₄ on a shot image are designated as the coordinates M₁(X₁, Y₁) and M₄(X₄, Y₄) describing the positions of the markers 121d and 124d appearing in the shot image information.

If a detected marker is composed of a plurality of pixels, the problem arises as to the coordinates of which of the pixels should be determined as Mᵢ(Xᵢ, Yᵢ). With respect to this problem, it is difficult to generalize how to determine the pixel to be used and express it mathematically, since the determination depends on the shape and display position of the marker. Yet, in this example, each marker is a square and displayed at a corner of the display area of the display device, so that Mᵢ(Xᵢ, Yᵢ) is determined as follows.

(i) The coordinates of the top left pixel of a pixel group constituting the marker 121d are determined as M₁(X₁, Y₁).

(ii) The coordinates of the bottom left pixel of a pixel group constituting the marker 122d are determined as M₂(X₂, Y₂).

(iii) The coordinates of the top right pixel of a pixel group constituting the marker 123d are determined as M₃(X₃, Y₃).

(iv) The coordinates of the bottom right pixel of a pixel group constituting the marker 124d are determined as M₄(X₄, Y₄).

In the above manner, the marker detection process is performed to detect the four sets of coordinates M₁(X₁, Y₁) to M4(X₄, Y₄) describing the positions in a shot image at which the respective four markers 121d-124d appear. As a result, the point information Qb is duly generated.

Note in Equation 4 of the above example, the point information Qb is generated based on two sets of coordinates, namely M₁(X₁, Y₁) and M₄(X₄, Y₄). Alternatively, the point information Qb may be generated based on the four sets of coordinates, namely M1(X₁, Y₁)-M₄(X₄, Y4). Although it is easier to generate the point information Qb based on the two sets of coordinates M₁ and M₄, the point information Qb generated based on the four sets of coordinates M₁-M₄ improves the accuracy of coordinate conversion.

In the event that the display position of a marker is shifted, the coordinates Mᵢ are calculated in consideration of the shift amount of the marker in addition to the detected position of the marker and the like. Details thereof will be described later.

Note in addition that the sets of coordinates M₁-M₄ may be calculated based on the detected position and detected size of each marker.

### (3) Transmission of Point Information Qb and Operation Execution

In the example shown in FIG. 21, on the portable information terminal 600, a user designates point described by the coordinates Qa, which corresponds to a region for requesting the “hue” adjustment on the operation menu 28. The designated coordinates Qa are converted by the display-device-information generating unit 137 so that the point information Qb is generated. The thus generated point information Qb(Xb, Yb) is transmitted as operation information to the television 2 etc., in Step S5 described above. When the television 2 etc., receives the operation information, the operation input unit 25 interprets the point information Qb as indicating a user operation designating the coordinates Qb of a point on the display screen of the television 2. As a result, it is interpreted that the “hue” adjustment (operation item image 28c) is selected from the operation menu 28, so that a sub-menu for hue adjustment is displayed. By repeating operations as described above, the user can remotely control the hue adjustment.

(4) The remote control described above is assumed to take time on the order of a few seconds to a few tens of seconds. During the time, the markers are displayed in smaller size, so that the loss of viewability of the operation menu, which is the primary screen picture of the display apparatus, is reduced.

Of the entire display-device-information generating unit 137 according to the present embodiment, part handling the coordinate conversion from the shot image coordinates Qa to display area coordinates Qb (i.e., part handling the generation of the point information Qb) constitutes the “coordinate converting unit”.

### <Process of Shifting Undetectable Marker>

Next, the following describes a process of shifting the display position of an undetectable marker if the display position is inappropriate.

The process of shifting an undetectable marker is described based on the following example.

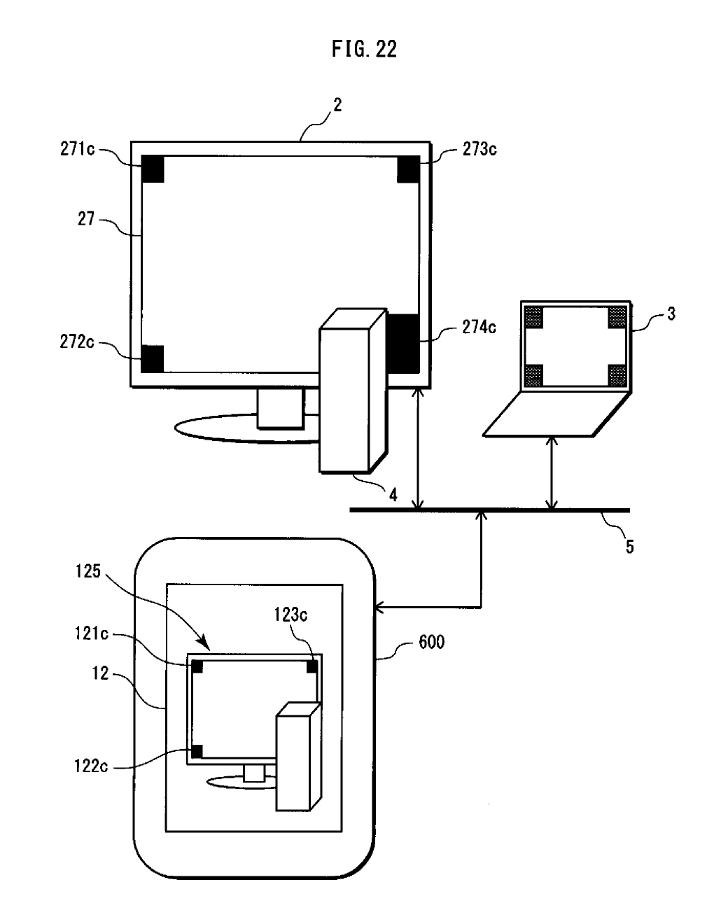

FIG. 22 shows an example in which an obstruction 4 is placed in front of the television 2 by someone other than the user. In this situation, of the markers 271c-274c displayed on the television 2, the marker 274c is hidden behind the obstruction 4 and thus cannot be seen. Since the hidden marker 274c was detected until the obstruction 4 is placed, so that the marker 274c is recognized as an undetectable marker. Thus, as described in Embodiment 2 above, the display size of the marker 274c is increased. Yet, even if the display size of the marker 274c is increased, the marker 274c still cannot be detected by being blocked by the obstruction 4. This is the situation shown in FIG. 22.

Note that it is not always the case that the obstruction 4 is placed near the television 2. For example, a glass or something placed near the user may obstruct the marker 274c from line of sight.

### (1) Overview of Marker Shift Process

Regarding an undetectable marker described in detail in Embodiment 2, the marker state determining unit 136 identify the cause of the marker being undetectable. More specifically, it is determined whether the marker is undetectable because the marker is hidden behind some obstruction or because the marker falls outside the image shooting area. The two states are collectively referred to as “obstructed, etc. state (i.e., predetermined state)”.

Here, the “obstructed, etc. state” is determined to be the cause leading to an undetectable marker when the following two conditions are both satisfied.

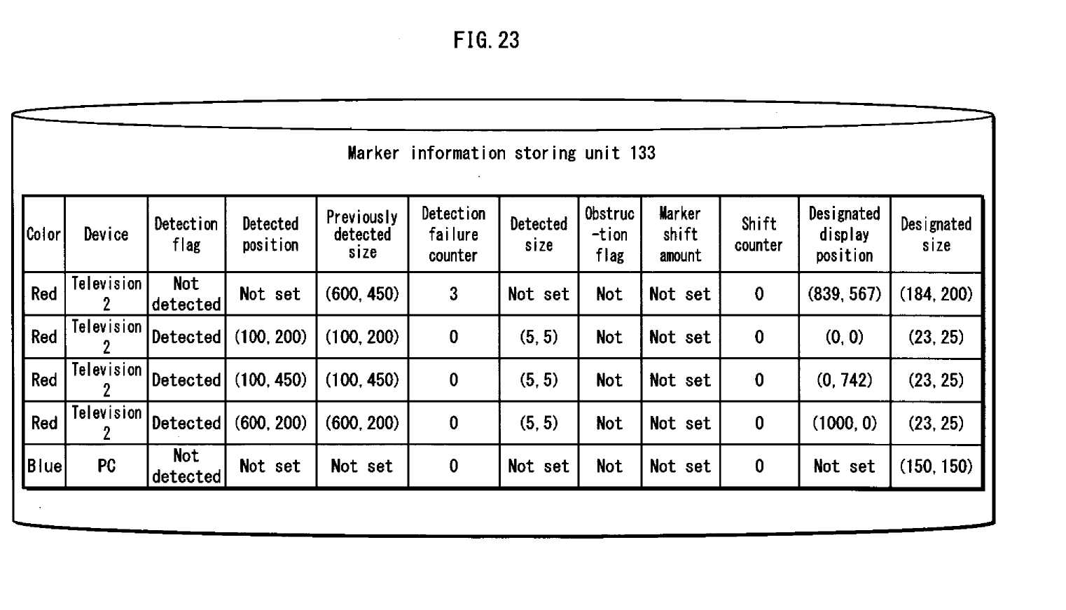

Condition 1: The marker still fails to be detected after repeating the display size change described in Embodiment 2 a predetermined number of times (E times). In order to make the determination, the marker information storing unit 133 is provided with a detection failure counter for keeping a count of the number of times detection of a marker is performed and failed (FIG. 23).

Condition 2: One or more markers other than the undetectable marker displayed on the same display device are detected. Here, the other markers displayed on the same display device as the undetectable marker mean all the markers other than the undetectable marker that are displayed on the same display device, provided that the display device displays more than one markers in total.

If the other markers are not detected either or not present (all the markers displayed on a display device are recognized as undetectable markers), it is assumed that the display device per se is entirely fall outside the image shooting area of the camera unit 11. Thus, the “obstructed, etc. state” is not the cause.

In FIG. 22, the marker 274c is recognized as an undetectable marker and the television 2 is the display device corresponding to the undetectable marker 274c. Further, the other markers, namely the markers 271c-273c corresponding to the television 2 are the “other markers”.

Note in the case that the display device displays only one marker in total, Condition 1 may be exclusively considered to determine the “obstructed, etc. state” is the cause. In this case, in addition, a modification may be made such that the display device dynamically operate to display one or more additional markers and the Condition 2 is then taken into account to make the determination.

The undetectable marker control unit 135 has, in addition to the functions described in Embodiment 2 above, a function for changing the display position of a marker determined undetectable by the marker state determining unit 136 due to the “obstructed, etc. state”.

FIG. 23 shows the marker information held in the marker information storing unit 133.

The marker information storing unit 133 has a storage area for storing the following entries in addition to those described in Embodiments 1 and 2: a designated display position of a corresponding marker, a detection failure counter, an obstruction flag, a shift counter, and a marker shift amount (FIG. 23). The designated display position (Xr, Yr) indicates that a corresponding marker is displayed so that the top left corner of the marker is located at the coordinates (Xr, Yr) on the display area of the television 2 etc.

The detection failure counter is used in detecting the “obstructed, etc. state”, which will be described later. The obstruction flag indicates whether or not a corresponding marker is in the “obstructed, etc. state”. The shift counter is used in the process of shifting the display position of the undetectable marker (marker in the “obstructed, etc. state”).

The marker shift amount (Xm, Ym) indicates that the marker is to be displayed at the position shifted Xm pixels in the X axis and Ym pixels in the Y axis from the designated display position. In the coordinate system describing positions in the display area of the television 2 etc., the origin point (0, 0) is at the top left corner, so that the X-coordinate increases toward the right and the Y-coordinate increase toward the bottom.

### (2) Undetectable Marker Process 2

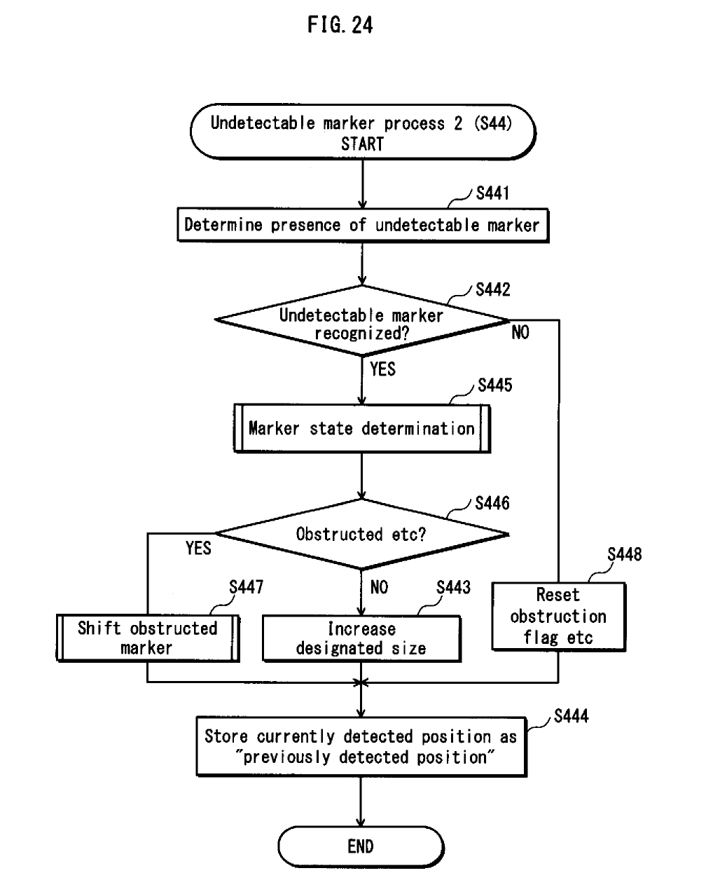

The following describes the processing performed by the portable information terminal 1 having the structure shown in FIG. 22, with reference to the flowcharts shown in FIGS. 24, 25, and 26.

The television 2 shown in FIG. 22 displays the markers 271c-274c one at each corner of the display screen, according to the marker display instruction given (based on the marker information shown in FIG. 23) by the portable information terminal 1. Here, the marker 274c is hidden behind the obstruction 4. Therefore, any image of the marker 274c does not appear in the shot image information generated by the portable information terminal 1 (naturally, no such an image appears on the display unit 12 that simply displays the shot image as it is). Consequently, the point information Qb cannot be calculated using information acquired by detecting all the markers displayed at the four corners as described above. Optionally, it is possible to calculate the point information Qb as long as two markers 272c and 273c are detected. Yet, for the purpose of description, the detection of the marker 274c is attempted again.

In this situation, the marker display control device installed within the portable information terminal 600 determines that the marker 274c is obstructed and adjusts the display position of the marker 274c. Note that the flowchart of the undetectable-marker-display-mode-change process 2 (hereinafter, “undetectable marker process 2”) shown in FIG. 24 is based on the flowchart of the undetectable marker process shown in FIG. 19 with some additional steps. In this example, it is assumed that the marker information storing unit 133 of the portable information terminal 600 holds the marker information shown in FIG. 23.

FIG. 24 is a flowchart of the undetectable-marker-display-mode-change process 2 (hereinafter, “undetectable marker process 2”).

Steps S441-S443 are performed in the manner described in Embodiment 2.

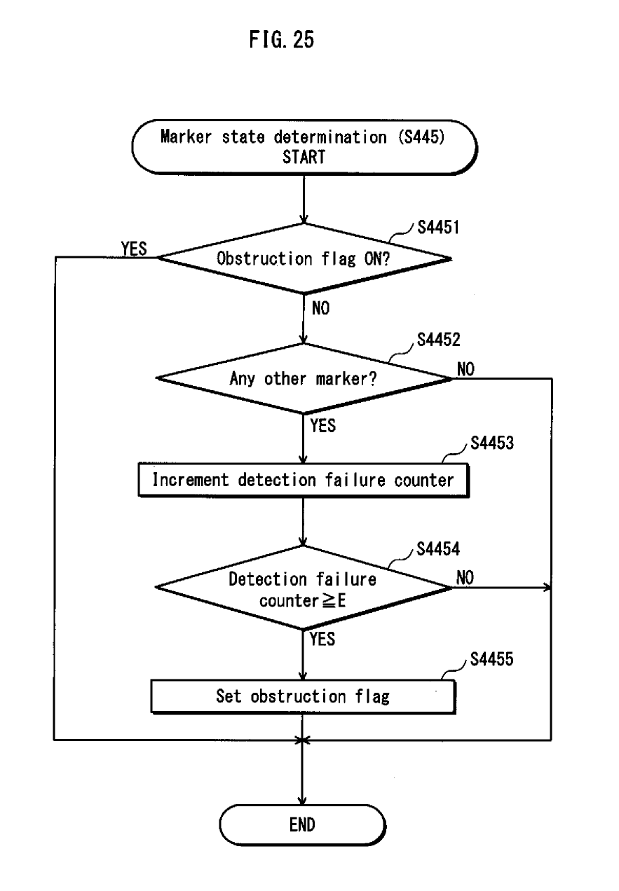

If an undetectable marker is recognized in Step S442, the process of determining whether the marker is in the state being obstructed, etc. (hereinafter, “obstructed, etc. state”) (Step S445). More specifically, the undetectable marker control unit 135 requests the marker state determining unit 136 to determine whether the detection failure has occurred because the marker 274c is in the “obstructed, etc. state” or not. The marker state determining unit 136 makes this determination (Step S445) of the marker state by performing the processing steps of the flowchart shown in FIG. 25.

If it is determined in Step S446 that the marker is not in the “obstructed, etc. state”, the process of increasing the designated size is performed (Step S443). On the other hand, if it is determined that the marker is in the “obstructed, etc. state”, the process of shifting the display position of the marker is performed (Step S447).

If no undetectable marker is recognized in Step S442, Step S448 is performed to reset the obstruction flag, the detection failure counter, etc., all to OFF (indicating not obstructed) or “0”.

### (3) Marker State Determining Process

The following now describes the marker state determining process of determining whether a marker is in “obstructed, etc. state” (Step S445) shown in FIG. 25.

In Step S4451, the marker state determining unit 136 acquires a piece of marker information corresponding to the undetectable marker from the marker information storing unit 133 and checks the value of the obstruction flag. If the obstruction flag is set to the value indicating “obstructed (ON)”, the marker state determining process is terminated without performing the steps of determining whether the marker is in the “obstructed, etc. state” described below. In this example, the obstruction flag in a piece of marker information corresponding to the marker 274c is not set to the value indicating “obstructed” (i.e., obstruction flag is OFF), Step S4452 is performed next.

In Step S4452, it is determined whether “other markers” displayed on the same display device as the undetectable marker have been detected. This determination is made because if “other markers” have not been detected, it is assumed that the display device displaying the undetectable marker entirely fall outside the image shooting range of the image shooting unit 11. Therefore, the step of determining the “obstructed, etc. state” is not necessary. In this example, the “other markers”, namely the markers 271c-273c, displayed on the television 2 together with the marker 274c are all associated with a detection flag set to the value indicating “detected (ON)” as shown in FIG. 23. That is, the “other markers” on the television 2 have been detected and thus Condition 2 is satisfied. Consequently, Step S4453 is performed next.

In Step S4453, the value of the detection failure counter included in a piece of marker information corresponding to the undetectable marker is incremented. In this example, the detection failure counter in the piece of marker information for the marker 274c holds the value “3”, so that this value is incremented to “4”.

In Step S4454, it is determined whether the detection failure counter of the piece of marker information for the undetectable marker holds a value equal to or greater than the predetermined set value E. If the counter value is less then the set value E, it is assumed that the undetectable marker may be detectable by performing the process of increasing the display size described in Embodiment 2. Thus, the marker state determining process is terminated. In this example, suppose that the set value E is “4”, the detection failure counter in the piece of the marker information for the marker 274c holds the value “4”. Thus, the above condition is satisfied. That is, Condition 1 is satisfied and thus Step S4455 is performed next.

In Step S4455, the obstruction flag in the piece of marker information for the undetectable marker is updated and thus holds the value indicating “obstructed (ON)”. In this example, the obstruction flag in the piece of marker information for the marker 274c is updated to indicate “obstructed”. Then, the marker state determining process is terminated.

The following now describes the processing flow to be followed if it is determined in Step S4453 that the value of the detection failure counter is equal to “2” or smaller. Note that the initial value of the detection failure counter is “0”. Therefore, until the third iteration of the marker state determining process (Step S445) after the undetectable marker is recognized (Steps S441 and S442), the determination made in Step S4453 results in that the detection failure counter holds the value “equal to 3 or less”. Consequently, the marker state determining process is terminated without setting the obstruction flag to ON.

As a result, in the undetectable marker process 2 (FIG. 24), Step S443 is performed to increase the designated size of the undetectable marker. Upon receipt of the resulting marker-display-instruction information, the television 2 increases the display size of the undetectable marker 274c. However, the undetectable marker 274c is hidden behind the obstruction 4 and therefore fails to be detected. Therefore the marker 274c is again recognized as undetectable marker in Steps S441 and S442.

By repeating the above processing, the value of the detection failure counter eventually reaches the set value E described above. As a result, Condition 1 is satisfied and it is determined that the marker is in the “obstructed, etc. state”. On the other hand, if the undetectable marker is successfully detected, there is no undetectable marker any more. Thus, the determination in Step S442 results in “NO” and the detection failure counter is reset to “0” in Step S448.

### (4) Overview of Marker Shift Process

Referring back to FIG. 24, if the obstruction flag is set to ON in Step S4455 shown in FIG. 25, Step SS447 is performed next.

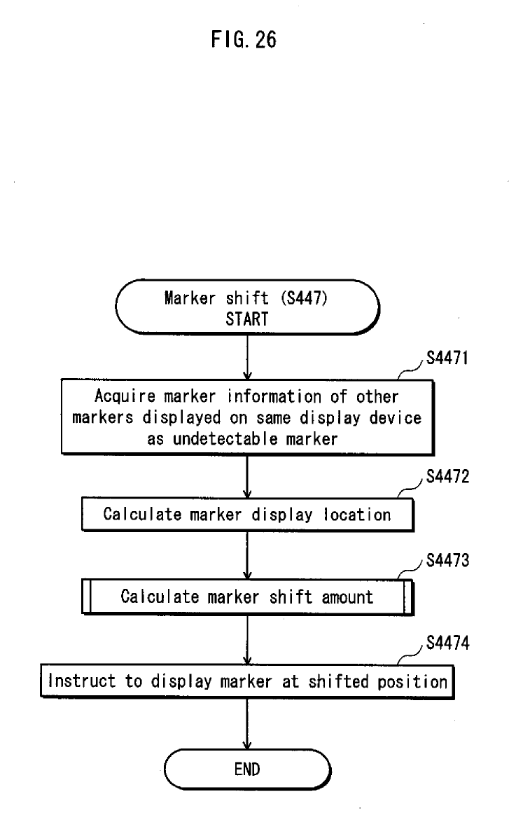

In Step S446, the undetectable marker control unit 135 shifts the display position of the undetectable marker that is determined as being obstructed, etc. (i.e., the marker with the obstruction flag indicating “obstructed” and such a marker is hereinafter referred to the marker in the “obstructed, etc. state”) to an appropriate position to make the marker detectable. The following describes the process of shifting the display position of the marker in the “obstructed, etc. state”. (Step S447), with reference to the flowchart shown in FIG. 26.

In Step S4471, the undetectable marker control unit 135 acquires marker information for the other markers displayed on the same display device as the undetectable marker in the “obstructed, etc. state”. In this example, the marker 274c is an undetectable marker that is in the “obstructed, etc. state”, the “television 2” is the display device displaying the marker 274c, and the markers 271c-273c are detected as the other markers. Accordingly, in Step S4471, the pieces of marker information corresponding to the respective other markers are read.

In Step S4472, the undetectable marker control unit 135 determines the approximate location of the other markers as well as of the undetectable marker on the display area of the display device, based on the designated display positions and the previously detected positions and the like of the respective markers. Here, the “location of a marker on the display area” does not refer to detailed information such as coordinates. Rather, the location refers, for example, to information roughly indicating where in the display area of the display device the undetectable marker is displayed.

In this example, the markers are displayed one at each corner of the display area of the display device, so that the approximate marker locations are determined as “top left”, “bottom left”, “top right” and “bottom right”. In addition, the marker 274c is displayed at “bottom right”.

In Step S4473, the marker shift amount is calculated based on the approximate marker locations determined in Step S4472 described above as well as the designated display position and designated size of the undetectable marker that is in the “obstructed, etc. state”.

In Step S4474, the marker-display-instruction information is transmitted to the television 2, as will be described later in detail.

### (5) Shift Amount Calculating Process

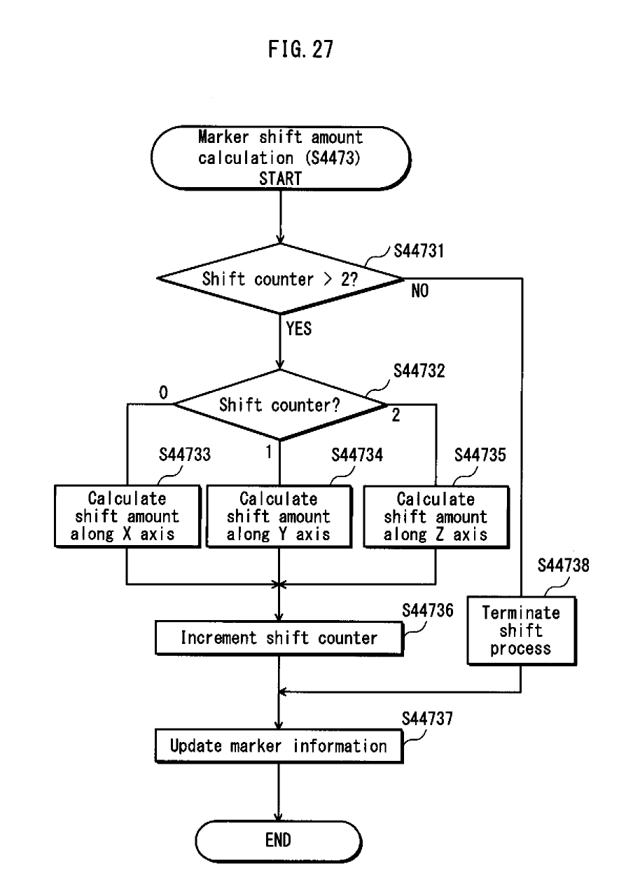

FIG. 27 is a flowchart of the marker-shift-amount-calculating process (Step S4473).

In the marker-shift-amount-calculating process, the marker in the “obstructed, etc. state” is shifted from the initial designated display position sequentially in the horizontal direction (X-axis direction), vertical direction (Y-axis direction) and diagonal direction to make the marker detectable. If the marker is detected after being shifted for the first or second time, any further shift of the marker will not take place thereafter. On the other hand, if the marker detection still fails after being shifted for the third time, the marker shift process is terminated.

The following is a more specific description.

First, if it is judged in Step S44731 that the shift counter holds the value equal to “2” or smaller, the processing moves onto Step S44732. The shift counter keeps the count of how many times the marker in the “obstructed, etc. state” has been moved.

Through the determination in Step S44732, one of Steps S44733-S44734 is selected depending on the value of the shift counter.

If the value of the shift counter is “0”, Step S44733 is performed to calculate the shift amount along the X axis direction. Note that one of the plus and minus directions along the X axis is selected depending on the current display position of the undetectable marker so as to move the undetectable marker toward the center of the display area. In this example, the undetectable marker is currently displayed at the “bottom right” of the display area, so that the minus direction (i.e., the direction toward the left) is selected.

The shift amount is calculated so that the center of the marker comes to be placed at the center of the display area along the X axis.

In this example, the center of the display area of the television 2 along the X-axis is at the X coordinate (512) and the center of the marker along the X-axis direction is at the X coordinate (931). Therefore, the shift amount is calculated to be −419 by subtracting 931 from 512.

Note that each of Steps S44734 and S44735 is performed in a similar manner to Step S44733, so that the shift amount is calculated based on the coordinates (512, 384) describing the center of the display area of the display device, in order to bring the center of the marker to coincide with the center of the display area in the Y axis direction or both the X axis and Y axis directions.

In Step S44736, the value of the shift counter is incremented by 1. By incrementing the shift counter, Step S44732 performed in the next iteration of the marker shift process results in a branch to Step S44734. As a result, the marker is shifted in the vertical direction. In yet another iteration, Step S44732 results in a branch to Step S44735. Note that if the shift in the X axis direction makes the marker detectable, the obstruction flag is reset to OFF in Step S448. As a result, any further iteration of the marker shift process does not take place, so that the display position of the marker is not shifted in the Y axis.

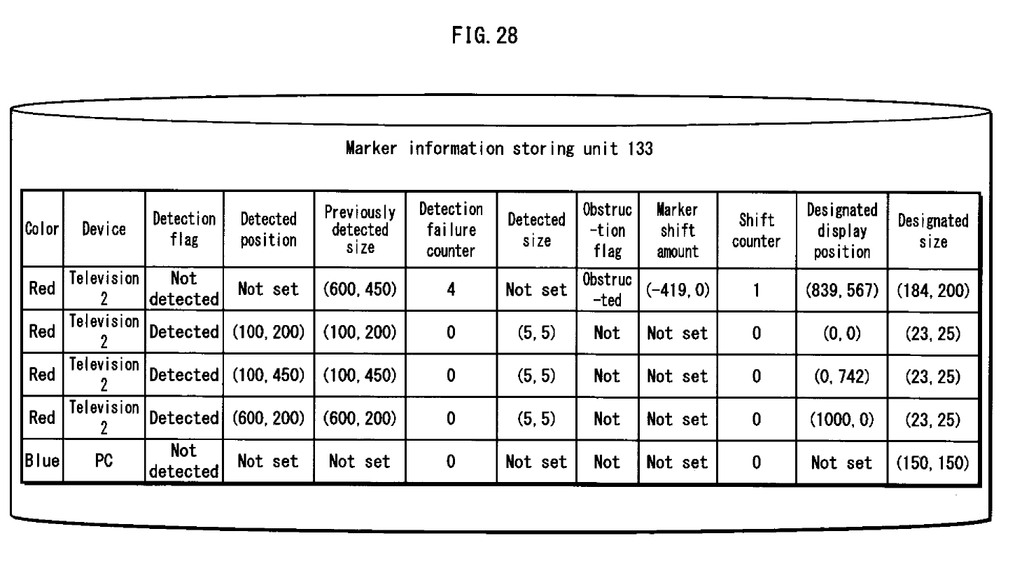

In Step S44737, the marker shift amount (−419, 0) of the undetectable marker in the “obstructed, etc. state” is stored to the marker information storing unit 133. FIG. 28 is a view showing the contents stored in the marker information storing unit 133 after the marker shift amount is stored.

Note that the marker may remain undetectable even after shifting the marker three times. In that case, the shift counter comes to hold the value “3”, so that the determination in Step S44731 results in “NO”. Then, in Step S44738, the marker shift process is terminated. More specifically, the values of the detection failure counter and the shift counter are reset to “0”, the obstruction flag is set to OFF, the previously detected position is reset to indicate “not set”, and the designated size is set to the same value as the designated size of other markers.

As a result of the terminating process, the marker 274d is no longer recognized as an undetectable marker, so that the marker 274d is not subjected to another detection process. In the event that the obstruction 4 is moved to another location and an image of the marker 274d is shot again, the marker 274d is duly detected.

After the terminating process, the display-device-control process may be terminated or continued using the remaining three markers 271d-273d.

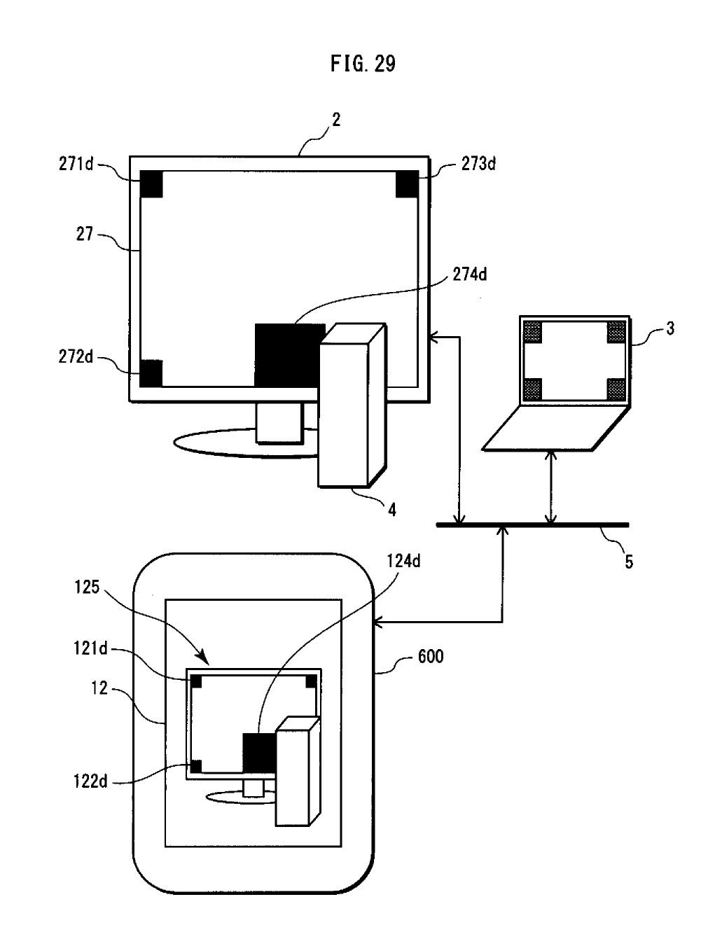

In Step S4474, the marker display instruction unit 134 sends the marker-display-instruction information containing the thus calculated marker shift amount and the designated display position to the transmission unit 15 for transmission to the display device displaying the undetectable marker. The receiving unit 21 of the television 2 receives the marker-display-instruction information transmitted from the transmission unit 15 and inputs the received marker-display-instruction information into the marker-display-information control unit 22. Upon receipt of the input, the marker-display-information control unit 22 performs the marker-display-information-update process according to the marker-display-instruction information (Step S16), so that the “color”, “designated size”, “designated display position” and “marker shift amount” are updated. In addition, the marker-display-information control unit 22 performs the marker superimposition process according to the marker display information (Step S17), so that the marker of the designated color and size (Wr, Hr) is displayed at a point on the display unit 27 defined by the coordinates (Xr+Xm, Yr+Ym) in a manner being superimposed on a screen picture. In this example, the marker 274c is displayed at (420, 567) to avoid being hidden behind the obstruction 4 (FIG. 29).

That is, as shown in FIG. 29, the marker 274d is shifted to the center of the display area in the X axis direction, so that the marker 274d is no longer obstructed, etc. and becomes available for image shooting. Therefore, in the subsequent detection process, the portable information terminal 600 is ensured to duly detect a marker shot image 124d (i.e., an image of the marker 274d) from the shot image information.

In addition, the marker-size-adjustment process (S4) described in Embodiment 1 may be performed at this stage on the thus detected marker 274d, so that the display size of the marker 274d is adjusted to the smallest detectable size.

In the present embodiment, the marker-display-instruction information containing the “marker shift amount” is transmitted to the television 2 and this transmission corresponds to “instruct to change the display position of the marker”.

At the time of transmitting the marker display information, the marker display instruction unit 134 may calculate the “designated display position after the shift” by adding the marker shift amount to the designated display position of the undetectable marker and transmit the designated display position after the shift to the television 2 as part of the marker-display-instruction information.

### (6) Generating Point Information Qb

In the present embodiment, the point information Qb is generated as described above based on the sets of coordinates M1-M4 of the markers. Here, the coordinates M4 of the shifted marker 274d is calculated by subtracting the marker shift amount from the actual coordinates of the marker 274d. That is, from the coordinates Mi(Xi, Yi) of the marker after the shift and the shift amount (Xm, Ym), the following equation gives the coordinates Mgi(Xgi, Ygi) at which the marker before the shift would be detected if the marker were not hidden behind the obstruction 4.

Note that (Wa, Ha) express the size (in terms of the numbers of pixels) of the entire display area of the television 2 as appeared in the shot image. In addition, (Wb, Hb) correspond to the actual size of the display area (resolutions) of the television 2 (see Equation 4).

$${X}_{gi} = {X}_{i} - \frac{{W}_{a}}{{W}_{b}} \cdot {X}_{m} \\ {Y}_{gi} = {Y}_{i} - \frac{{H}_{a}}{{H}_{b}} \cdot {Y}_{m} \qquad [ Equation 5 ]$$

By calculating the coordinates Mgi, the generation of point information Qb is facilitated.

In the present embodiment, part of the display-device-information generating unit 137 that handles the calculation of the coordinates Mgi(Xgi, Ygi) constitutes the “position calculating unit”.

### (7) Recapitulation

Through the undetectable marker process 2, the display position of the marker in the “obstructed, etc. state” is shifted to be detectable attain. By virtue of the above process, it is allowed to display small-sized markers one at each of the four corners of the display area of the television 2 to reduce the loss of viewability of the television 2. If any marker is placed in the “obstructed, etc. state”, the marker is then moved to ensure the marker to be detectable again. In addition, if any marker is shifted and detected, Step S42 described above is performed so that the designated size of the marker is reduced, so that the display size of the marker appearing on the television 2 is reduced accordingly.

In the present embodiment, the marker-display-mode changing unit 630 is composed of the display marker control unit 132, the marker information storing unit 133, the marker display instruction unit 134, the undetectable marker control unit 135, and the marker state determining unit 136.

### [Modification 1]

Embodiment 3 described above may be modified to perform the undetectable marker process 2 in consideration of the movements of the camera unit 11. More specifically, when the portable information terminal 600 is turned to a different direction by the user, the position at which each marker is detected changes. By comparing the previously detected position and currently detected position of each marker other than the undetectable marker, the amount of change in the detected positions is calculated.

Based on the previously detected position of the undetectable marker and the amount of change in the detected positions of other markers, the expected detected position at which the undetectable marker is would be detected in the current detection is calculated. If the expected detected position falls outside the display unit 12 of the portable information terminal 600, it is determined that the undetectable marker is located outside the image shooting area. In this case, it is determined that the marker is located outside the image shooting area without performing the process of increasing the designated size of the marker.

If the undetectable marker is located outside the image shooting area, the undetectable marker is made detectable again, by changing the designated display position to fall within the image shooting area.

More specifically, suppose that one or more of the markers do not appear in a shot image because the one or more markers are hidden behind an obstruction or fall outside the image shooting area. In either case, the marker display control device 613 may operate to change the display positions of the respective markers to make the markers detectable again.

In Embodiment 3 described above, if any undetectable marker is recognized, it is possible to first determine whether the undetectable marker is located outside the image shooting area. Only if the undetectable marker is determined to fall within the image shooting area, it is then determined if the undetectable marker is in the “obstructed, etc. state”.

### [Modification 2]

In Embodiment 3 described above, it is determined in advance that the display position a marker in the “obstructed, etc. state” is shifted to the center of the display area. Alternatively, however, the shift amount may be determined at random.

In Step S4473, the marker shift amount is calculated based on the display positions of the other markers located in Step S4472 described above as well as the designated display position and designated size of the undetectable marker being obstructed, etc. In this modification, the direction in which the marker is to be shifted (i.e., the marker shift direction) and the distance by which the marker is to be shifted (i.e., the marker shift distance) are defined at the time of calculating the marker shift amount.

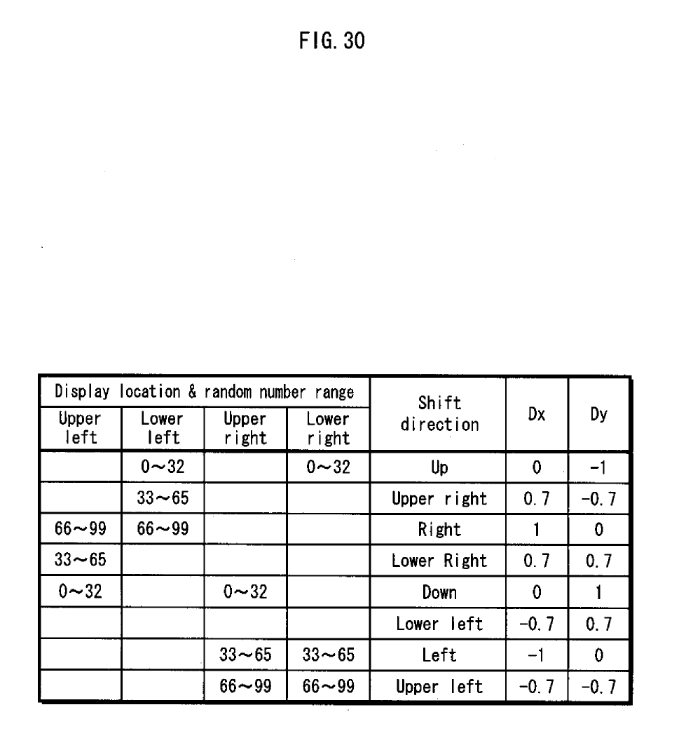

The marker shift direction is a value determined based on the “display position” of the marker to be shifted and indicates the direction into which the marker is to be shifted. FIG. 30 shows a table used for determining the marker shift direction depending on the display position and a random number Rp (which takes any value ranging from 0 to 99). In this example, the display position of the marker 274c is “lower right”, so that one of the “up (when Rp falls within the range of 0-32)” “left (when Rp falls within the range of 33-65)” and “upper left (when Rp falls within the range of 66-99)” is selected according to the value of the random number Rp. Note that any of the options of “left”, “upper left” and “up” may be selected at equal probability as shown in FIG. 30. Alternatively, weights may be assigned so that each option is selected at different probability. In this example, the random number Rp is “35” and thus “left” is selected.

The marker shift distance shows the distance by which the marker is to be shifted in the marker shift direction as determined above. The marker shift amount is calculated based on the designated size of the undetectable marker in the “obstructed, etc. state”. More specifically, suppose that a random number Rv is a value greater than 0.0 and equal to or less than 1.0 and then the marker shift distance V is given by Equation 6 below.

$$V = \frac{( 1 + 2 {R}_{v} ) \sqrt{{W}_{r} \cdot {H}_{r}}}{2} \qquad [ Equation 6 ]$$

In this example, it is assumed that Rv=0.5, so that V=192 is calculated.

Note that the random number Rv is generated by the undetectable marker control unit 135.

Based on the marker shift direction and the marker shift distance, the marker shift amount (Xm, Ym) is given by Equation 7 below.

Xₘ=V·Dₓ

Yₘ=V·D_{y} [Equation 7]

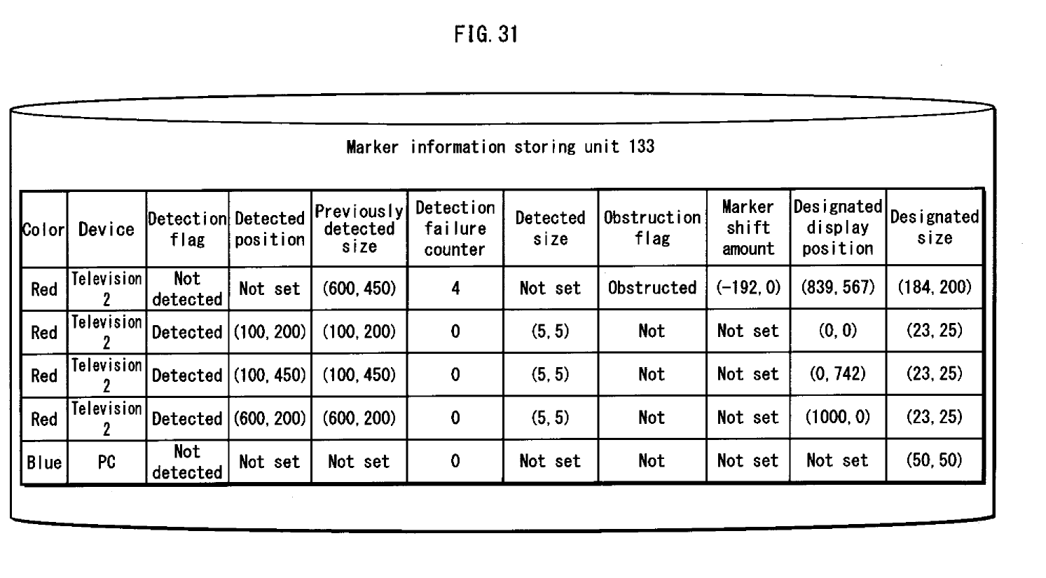

Note that in Equation 7 defining the marker shift direction, Dx denotes the shift amount in the lateral direction, whereas Dy denotes the shift amount in the vertical direction as shown in FIG. 30. In this example, Dx=−1 and Dy=0, so that the marker shift amount is given as (−192, 0). In this state, the stored contents of the marker information storing unit 133 are as shown in FIG. 31.

By employing a random number to determine the shift amount of a marker, the display position of the marker is changed to a variety of positions. Therefore, even if it is not clear which part of the display area of the television 2 etc., appears in a shot image, it is likely that an undetectable marker is successfully detected by being repeatedly shifted to a different display position.

### [Supplemental Note]

(1) The specific embodiments and modifications are described above merely as examples and the scope of the present invention is not limited thereto. Furthermore, it is naturally appreciated that various other changes and modifications may be made without departing from the gist of the present invention.

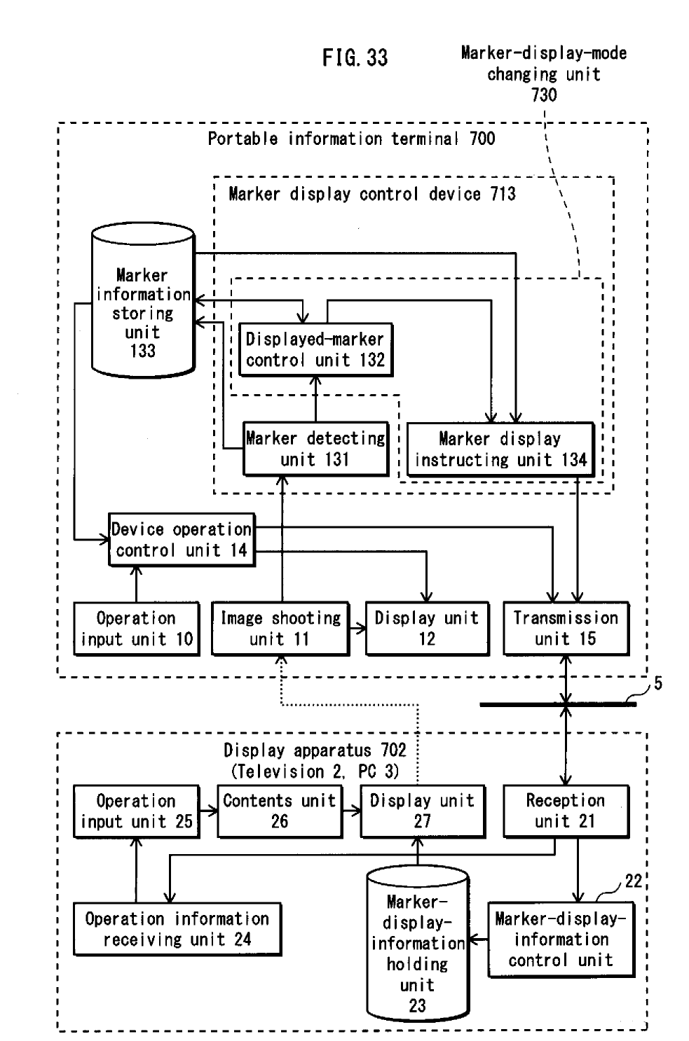

(2) FIG. 33 is a block diagram showing the structures of an operation device 700 and a display apparatus 702 (the television 2 or PC 3). The portable information terminal 700 has a marker display control device 713. The marker display control device 713 consistent with an embodiment of the present invention is connected to a display apparatus 702 via the communications unit 5 and controls the display apparatus 702 to display a marker used for recognizing the display apparatus 702. The marker display control device 713 includes the marker detecting unit 131 and a marker-display-mode changing unit 730. The marker detecting unit 131 detects any marker for recognizing the display apparatus 702 from an image obtained by shooting a display screen of the display apparatus 702. Based on a result of the marker detection, the marker-display-mode changing unit 730 instructs the display apparatus 702 that is displaying the detected marker to change the display mode of the marker.

With the above configuration, the same advantageous effect as Embodiment 1 is achieved. In addition, the operation device 700 may be comprised, for example, of a portable information terminal. The display apparatus 702 may be comprised of a display device, such as a television or PC. Note that in FIG. 33, the same components as those shown in FIG. 1 are denoted by the same reference signs.

(3) In the embodiments and modifications described above, the marker-display-information control unit 22 included in the television 2 may additional have the function of instructing the display unit 27 to display a marker or sending image information of a marker to the display unit 27.

(4) In Embodiments 1 and 2 described above, the display device may display a plurality of markers in a manner similar to Embodiment 3. In addition, the portable information terminal according to Embodiments 1 and 2 may be additionally provided with the coordinates conversion function, so that the coordinates Qa(Xa, Ya) describing a point on the shot image at which the display device appears are converted into the coordinates Qb(Xb, Yb) describing a point on the actual display area of the display device.

(5) In the embodiments and modifications described above, the marker detection process is performed to detect an image of a marker appearing in the shot image information. To put it simply, this marker detection process is said to be a process of detecting an image of a marker from a shot image.

(6) The marker display control device according to any of the embodiments (or modifications) described above may be typically implanted as an LSI, which is an integrated circuit. The marker display control device may be realized on a single chip or a plurality of chips. Furthermore, it is applicable that part of the marker display control device is realized on one or more chips.

Although LSI is specifically mentioned herein, it may be referred to as IC, system LSI, super LSI, or ultra LSI, depending on the packaging density. In addition, the scheme employed to realize an integrated circuit is not limited to LSI and such an integrated circuit may be realized by a dedicated circuit or by a general-purpose processor. For example, it is applicable to use an FPGA (Field Programmable Gate Array) that enables post-manufacturing programming of an LSI circuit or a reconfigurable processor that allows reconfiguration of connection between circuit cells within an LSI circuit and their settings. When any new circuit integration technology becomes available or derived as the semiconductor technology advances, such new technology may be employed to integrate the functional blocks. One possible candidate of such new technology may be achieved by adapting biotechnology.

(7) Furthermore, a marker display control program may be written to realize at least part of the processing steps performed by the marker display control device described in any of the Embodiments and the program stored in memory may be read and executed by a CPU (Central Processing Unit), for example. In addition, such a program may be recorded onto a recording medium(a non-transitory recording medium, for example) and distributed.

### INDUSTRIAL APPLICABILITY

A marker display control device according to the present invention has, for example, a function of adjusting the size of a marker displayed on a display apparatus, such as a television, to a detectable size. Such a marker is used for recognition of the display apparatus, so that the marker display control device is suitably usable in a remote control for the display apparatus. In addition, the marker display control device is also applicable to give a remote control function to an information terminal, such as a mobile phone, a portable music player, or a portable information terminal or to improve the remote control function of such an information terminal

### REFERENCE SIGNS LIST

1 portable information terminal

10 operation input unit

11 image shooting unit (camera unit)

111 shot image

12 display unit

121 marker 1 appearing in shot image

122 marker 2 appearing in shot image

123 marker 3 appearing in shot image

124 marker 4 appearing in shot image

13 marker display control device

130 marker-display-mode changing unit

131 marker detecting unit

132 displayed-marker control unit

133 marker information storing unit

134 marker display instructing unit

135 undetectable marker control unit

136 marker state determining unit

137 display-device-information generating unit

14 device operation control unit

15 transmission unit

2 television (display device)

21 reception unit

22 marker-display-information control unit

23 marker-display-information holding unit

24 operation information receiving unit

25 operation input unit

26 contents unit

27 display unit

271 marker 1

272 marker 2

273 marker 3

274 marker 4

3 PC (display device)

4 obstruction

5 communications unit

1. A marker display control device for controlling one or more display apparatuses connected thereto via a communications unit, so that each display apparatus displays a marker to be used for recognizing the display apparatus, the marker display control device comprising:
a marker detecting unit operable to detect a marker from a shot image of a display screen of one of the display apparatuses, the marker to be used for recognizing the display apparatus; and
a marker-display-mode changing unit operable to instruct, based on a result of the marker detection, the display apparatus displaying the marker to change a display mode of the marker.

2. The marker display control device according to claim 1, wherein
the marker-display-mode changing unit instructs the display apparatus displaying the marker detected by the marker detecting unit to reduce a total display area occupied by the marker.

3. The marker display control device according to claim 2, further comprising:
an image shooting unit operable to repeatedly shoot images of the marker, wherein
the marker detecting unit detects the marker from the images sequentially shot by the image shooting unit, and
when the marker detecting unit fails to detect a marker that was detected in a previous detection, the marker-display-mode changing unit instructs a display apparatus displaying the marker failed to be detected to increase a display size, or to change a display position, of the marker failed to be detected.

4. The marker display control device according to claim 3, further comprising:
a marker information storing unit that stores, for each marker, a piece of marker information including (i) information indicating a display apparatus associated with the marker, (ii) marker identification information indicating a marker color assigned to the associated display apparatus, and (iii) a display size of the marker on the associated display apparatus.

5. The marker display control device according to claim 4, wherein
the display apparatus has a function of displaying a plurality of markers at separate locations on a display area of the display apparatus,
the marker-display-mode changing unit includes a marker state determining unit,
when a marker displayed on the display apparatus is currently undetectable by the marker detecting unit as a result of the marker being hidden behind an obstruction or that the marker falls outside an image shooting range of the image shooting unit, the marker state determining unit determines that the undetectable marker is in a predetermined state, and
the marker-display-mode changing unit instructs to change the display position of the marker determined by the marker state determining unit as being in the predetermined state.

6. The marker display control device according to claim 5, wherein
the marker-display-mode changing unit instructs to change the display position of the marker determined as being in the predetermined state toward a center of the display area in at least one of vertical and horizontal directions, while the display position of each marker other than the marker determined as being in the predetermined state is retained at a different one of four corners of the display area.

7. The marker display control device according to claim 2, wherein
the marker-display-mode changing unit instructs the display apparatus to reduce a display size of the marker appearing in the shot image to a size that is smaller than a size of the marker as detected by the marker detecting unit and no smaller than a predetermined minimum size for ensuring a marker to be detectable from a shot image.

8. The marker display control device according to claim 3, wherein
the marker-display-mode changing unit repeatedly instructs the display apparatus to reduce the display size of the marker until the marker is no longer detectable and to increase the display size of the marker once the marker has failed to be detected.

9. The marker display control device according to claim 2, wherein
the marker-display-mode changing unit specifies a marker color to be used by each display apparatus, and
the marker detecting unit detects as a marker any pixel group appearing, in the shot image, in a specified color and a size no smaller than a predetermined minimum size.

10. The marker display control device according to claim 1, further comprising:
a coordinate conversion unit operable to convert coordinates describing a point on a shot image of a screen displayed on one of the display apparatuses into coordinates describing a point on the display area of the display apparatus, wherein
the marker detecting unit at least detects a position of a marker on the shot image, and
the coordinate conversion unit at least performs the coordinate conversion based on the detected position of the marker.

11. The marker display control device according to claim 10, wherein
the display apparatus has a function of displaying, on the display area, a screen in which a marker and an operation menu appear, and
in response to designation of coordinates of a point on the shot image, the coordinate conversion unit converts the designated coordinates into coordinates of a corresponding point on the display area of the display apparatus.

12. The marker display control device according to claim 10, wherein
the marker display control device is incorporated into an operation device having:
a display unit displaying the shot image of the screen displayed on the display apparatus; and
an operation input unit for receiving an input designating coordinates of an arbitrary point on the display unit,
the display apparatus has a function of displaying, on the display area, a screen with a marker and an operation menu, and
the coordinate conversion unit converts the coordinates designated by the input received on the operation input unit into coordinates of a corresponding point on the display area.

13. The marker display control device according to claim 5 or 6, further comprising:
a coordinate conversion unit operable to convert coordinates describing a point on a shot image of a display screen of one of the display apparatuses to coordinates describing a point on the display area of the display apparatus; and
a position calculating unit operable to calculate, based on an amount of change in the display position of the marker and the display position of the marker as appeared in the shot image after the change, the display position of the marker before the change, wherein
the marker detecting unit detects the position of the marker as appeared in the shot image, and
the coordinate conversion unit performs the coordinate conversion based on a position of one or more markers not in the predetermined state and the calculated position of the marker in the predetermined state before the change.

14. An integrated circuit for controlling one or more display apparatuses connected thereto via a communications unit, so that each display apparatus displays a marker to be used for recognizing the display apparatus, the integrated circuit comprising:
a marker detecting unit operable to detect a marker from a shot image of a display screen of one of the display apparatuses, the marker to be used for recognizing the display apparatus; and
a marker-display-mode changing unit operable to instruct, based on a result of the marker detection, the display apparatus displaying the marker to change a display mode of the marker.

15. A marker display control method for controlling a display apparatus to display a marker used for recognizing the display apparatus, the marker display control method comprising the steps of:
acquiring a shot image of a display screen of the display apparatus;
detecting the marker from the shot image; and
instructing the display apparatus displaying the marker to change a display mode of the marker.
